(19) United States
(12) Patent Application Publication
(10) Pub. No.: US 2014/0125697 A1
(43) Pub. Date: May 8, 2014

(54) INFORMATION PROCESSING DEVICE, INFORMATION PROCESSING SYSTEM, SERVER, INFORMATION PROCESSING METHOD AND COMPUTER PROGRAM

(71) Applicant: NEC CORPORATION, Minato-ku, Tokyo (JP)

(72) Inventor: Akiko Suito, Tokyo (JP)

(73) Assignee: NEC CORPORATION, Minato-ku, Tokyo (JP)

(21) Appl. No.: 14/127,796

(22) PCT Filed: Jun. 20, 2012
(86) PCT No.: PCT/JP2012/066308

§ 371 Date: Dec. 19, 2013

(30) Foreign Application Priority Data
Jun. 21, 2011 (JP) 2011-137647

(51) Int. Cl. G06T 11/60

(52) U.S. Cl. CPC G06T 11/60
USPC 345/629

(57) ABSTRACT

To provide an information processing device which improves continuity of drawing information inputted in a manner to extend continuously across a plurality of display devices.

An information processing device 1 includes: a contents acquisition unit 101; an arrangement configuration acquisition unit 102 which acquires an arrangement configuration of a plurality of display devices; a contents output unit 103 which displays contents by regarding the plurality of display devices as a single display area on the basis of the arrangement configuration; a drawing information acquisition unit 104 which acquires, with respect to each of the display devices, drawing information to be displayed in a manner to be superposed on currently displayed contents; a continuity determination unit 105 which, if display devices performing superposed-display processing on respective ones of a plurality of pieces of drawing information acquired adjacently to each other in time are arranged adjacently to each other, determines whether or not there exists an operator's intention of continuity between these plurality of pieces of drawing information; a drawing information correction unit 106 which, if the intention of continuity is determined to exist, corrects these plurality of pieces of drawing information to become continuous with each other; and a display control unit 107 which makes the contents output unit redisplay the corrected drawing information along with the contents in a display mode where the former is superposed on the latter.

### TECHNICAL FIELD

The present invention relates to the field of information processing technology for processing information which is inputted with respect to contents displayed on a display device.

### BACKGROUND ART

There is known an information processing device for processing information which is inputted with respect to contents displayed on a display device. Here, the contents are referred to as data which can be displayed on a display device, for example, a still image such as a picture, a document containing text and images, a moving image such as a video image, or the like. The information inputted with respect to contents is referred to as information which is inputted for the purpose of editing currently displayed contents via an input device. As such input information, mentioned is drawing information inputted via a mouse, a touch panel or the like so as to superpose it on the contents

In recent years, as such an information processing device, there has appeared an information processing device which displays contents in a manner to extend across a plurality of display devices (that is, in a display mode where the contents are divided into parts which are separately displayed on respective ones of the plurality of display devices). For example, there are known a variety of all-in-one devices including a plurality of display devices, such as a notebook PC, tablet terminal and cellular phone terminal provided with two or more displays. In addition to such all-in-one devices, also known is an information processing device which is connected with a plurality of display devices and has a function to treat the plurality of display devices as a single display area. Further, also known is an information processing system which makes a plurality of computer devices each including a display device operated in combination and thereby makes them as a whole function as a single display area.

For example, Patent Document 1 describes an information processing device which processes information inputted with respect to contents displayed in a manner to extend across such a plurality of display devices. This information processing device acquires, as an arrangement configuration of a plurality of display devices, the number of sequentially arranged display devices in vertical direction and that in horizontal direction, and generates a virtual frame which regards the whole display area realized by the acquired arrangement configuration as a single display area. The information processing device then develops contents, which is to be displayed, over the virtual frame, and allocates thus developed parts of the contents to the respective display devices according to coordinates on the virtual frame, thus causing the display devices to display the contents.

The information processing device described in Patent Document 1 makes the contents, thus displayed in a manner to extend across a plurality of display devices, displayed also at an operational terminal. Here, the information processing device is connected with one or more such operational terminals. Each of the operational terminals comprises a single display device and displays contents displayed in a manner to extend across a plurality of display devices on the single display device of its own after adjusting the scale. Then, when the information processing device acquires drawing information inputted with respect to the contents via the operational terminals, it updates the contents developed over the virtual frame on the basis of the drawing information and, by using the updated drawing information, synchronizes information to be displayed on the plurality of display devices with those displayed at each of the operational terminals.

### CITATION LIST

### Patent Document

Patent Document 1 Japanese Patent Application Laid-Open No. 2009-37352

### SUMMARY OF INVENTION

### Technical Problem

The information processing device described in the above-mentioned Patent Document 1 acquires input information with respect to contents displayed in a manner to extend across the plurality of display devices via an input device of the operating terminals.

Here, assumed is a case where, in such an information processing device described above, which displays contents in a manner to extend them across a plurality of display devices, an input device capable of inputting information on coordinates in each display area of the plurality of display devices is provided. As such cases, mentioned are, for example, a case where touch panels are provided in a manner to be integrated with respective display areas of the plurality of display devices, a case where a mouse capable of designating information on coordinates in every display area of the plurality of display devices is provided, and the like. In such an information processing device, drawing information may be inputted in a manner to extend continuously across the display areas of the plurality of display devices. In such a case, drawing information which should have been inputted continuously as shown in FIG. 1A may be displayed discontinuously as shown in FIG. 1B. The reason will be described below. It is assumed that, in FIG. 1A, the left display device A is provided with a touch panel a in an integrated manner and the right display device B with a touch panel b also in an integrated manner. By detecting a contact position of a finger or a touch pen, the touch panels a and b acquire information on coordinates in the display areas of the display devices A and B respectively. There exists a gap area D between the display device A and B. Here, FIG. 1A shows that drawing information has been inputted with a single stroke 900 of a finger or a touch pen and is displayed in a display mode where it is superposed on contents. In this way, by the single stroke 900, the information processing device acquires drawing information 900a and drawing information 900b via the touch panels a and b respectively. FIG. 1B shows an example where contents superposed with the two pieces of drawing information 900a and 900b are displayed on a single display device. In FIG. 1B, the two pieces of drawing information 900a and 900b are displayed as lines discontinuous with each other. This is because the two pieces of drawing information 900a and 900b were inputted by the stroke 900 passing through the gap area D.

Also considered here is another case where, in FIG. 1A, in place of the touch panels a and b, a mouse capable of designating information on coordinates in both of the display devices A and B is provided. It is assumed that an operator inputs drawing information in a manner to extend it continuously across the display devices A and B. In this case, it can be considered that, because of the existence of the gap area D, the operator may stop the operation once at around the gap area and then start again. If the operation is stopped once in such a way, the information processing device may acquire the drawing information 900a and the drawing information 900b. As a result, as shown in FIG. 1B, when contents are displayed on a single display device, drawing information which should have been inputted in a manner to be continuous may be discontinuously displayed.

Such a problem arises when drawing information inputted in a manner to extend continuously across a plurality of display devices is displayed within the display area of a single display device as a result of scrolling, change in display magnification or the like of the contents. Such a problem arises also when contents are shared between, and displayed at both of, a device which displays contents by treating a plurality of display devices as a single device and another device. For example, in a remote conference system, the two terminals used by respective users display the same contents and redisplay drawing information, such as a line and a character, which is inputted at either of the terminals in a manner to be superposed on the contents kept as the background, along with the contents, in a display mode where the drawing information is superposed on the contents. In this case, it is assumed that the terminal used by one of the users displays contents in a manner to extend them across a plurality of display devices and includes an input device capable of inputting information on coordinates in the display area of each of the display devices. Also assumed is that the terminal used by the other user displays contents on a single display device. In such a case, drawing information inputted by the former user in a manner to extend continuously across the plurality of display devices may be displayed discontinuously at the terminal of the latter user. The same problem arises even when contents are shared between terminals both capable of displaying contents in a manner to extend them across a plurality of display devices, as a result of the difference between the terminals in arrangement configuration of the plurality of display devices, in display positions of the contents or in display magnification of the contents.

However, the above-mentioned Patent Document 1 gives no consideration to that drawing information extending continuously across a plurality of display devices may be inputted as described above, and accordingly, it cannot solve the above-described problem.

The present invention is an invention made to solve the above-described problem, and accordingly, one of its objectives is, with respect to an information processing device which displays contents in a manner to extend them across a plurality of display devices, to provide an information processing device which can improve the continuity of drawing information inputted in a manner to extend continuously across the plurality of display devices.

### Solution to Problem

An information processing device of the present invention includes: a contents acquisition unit which acquires contents; an arrangement configuration acquisition unit which acquires an arrangement configuration of a plurality of display devices; a contents output unit which displays the contents by regarding the plurality of display devices as a single display area on the basis of the arrangement configuration; a drawing information acquisition unit which acquires, with respect to each of the plurality of display devices, drawing information to be displayed along with currently displayed contents in a display mode where the former is superposed on the latter, via an input device for acquiring information on coordinates in the display areas of respective ones of the plurality of display devices; a continuity determination unit which, when display devices displaying areas in which a plurality of pieces of drawing information acquired adjacently to each other in time are respectively superposed on contents are arranged adjacently to each other, determines whether or not there exists an operator's intention of continuity between the plurality of pieces of drawing information; a drawing information correction unit which, if the intention of continuity between the plurality of pieces of drawing information is determined to exist, corrects the plurality of pieces of drawing information to become continuous with each other; and a display control unit which controls the contents output unit to redisplay the drawing information corrected by the drawing information correction unit along with the contents in a display mode where the former is superposed on the latter.

An information processing system of the present invention includes: a first information processing device according to the above-described one; and another information processing device which displays contents by regarding one or more display devices as a single display area and redisplays drawing information and currently displayed contents in a display mode where the former is superposed on the latter, wherein the first information processing device performs control to make the above-described plurality of pieces of drawing information having received correction redisplayed along with contents at the other information processing device in a display mode where the former are superposed on the latter, by sending the plurality of pieces of drawing information after correction to the other information processing device.

Another information processing system of the present invention includes a first information processing device which can display contents on a plurality of display devices, another information processing device which can display contents on one or more display devices, and a server, wherein: the first information processing device includes: a contents acquisition unit which acquires contents; an arrangement configuration acquisition unit which acquires an arrangement configuration of a plurality of display devices; a contents output unit which displays contents by regarding the plurality of display devices as a single display area, on the basis of the arrangement configuration; a drawing information acquisition unit which acquires, with respect to each of the plurality of display devices, drawing information to be displayed along with currently displayed contents in a display mode where the former is superposed on the latter, via an input device for acquiring information on coordinates in the display areas of respective ones of the plurality of display devices; and a display control unit which sends and receives contents and drawing information to and from the server, and controls the contents output unit to redisplay the received contents and drawing information; the server includes: a display control unit which performs control to make the first information processing device and the other information processing device share display contents with each other, by sending and receiving contents and drawing information to and from the first information processing device and the other information processing device; a continuity determination unit which, when display devices displaying areas in which a plurality of pieces of drawing information acquired adjacently to each other in time, among pieces of drawing information received from the first information processing device, are respectively superposed on contents are arranged adjacently to each other, determines whether or not there exists an operator's intention of continuity between the plurality of pieces of drawing information; a drawing information correction unit which, if the intention of continuity between the plurality of pieces of drawing information is determined to exist, corrects the plurality of pieces of drawing information to become continuous with each other, and subsequently causes the display control unit to send the corrected drawing information; and the other information processing device includes at least: a contents output unit which outputs contents to the one or more display devices; and a display control unit which controls the contents output unit to redisplay drawing information received from the server along with contents in a display mode where the former is superposed on the latter.

A server of the present invention is a server which is connected, in a manner to enable mutual communication, with: a first information processing device which displays contents by regarding a plurality of display devices as a single display area and acquires drawing information displayed along with contents in a display mode where the former is superposed on the latter; and another information processing device which displays contents by regarding one or more display devices as a single display area and redisplays drawing information along with the contents in a display mode where the former is superposed on the latter; wherein the server includes: a display control unit which performs control to make the first information processing device and the other information processing device share display contents with each other, by sending and receiving contents and drawing information to and from the first information processing device and the other information processing device; a continuity determination unit which, when display devices displaying areas in which a plurality of pieces of drawing information acquired adjacently to each other in time, among pieces of drawing information received from the first information processing device, are respectively superposed on contents are arranged adjacently to each other, determines whether or not there exists an operator's intention of continuity between the plurality of pieces of drawing information; a drawing information correction unit which, if the intention of continuity between the plurality of pieces of drawing information is determined to exist, corrects the plurality of pieces of drawing information to become continuous with each other, and subsequently causes the display control unit to send the corrected drawing information.

An information processing method of the present invention includes: acquiring contents; acquiring an arrangement configuration of a plurality of display devices; displaying the contents by regarding the plurality of display devices as a single display area, on the basis of the arrangement configuration; acquiring drawing information to be displayed along with currently displayed contents in a display mode where the former is superposed on the latter, with respect to each of the plurality of display devices, via an input device for acquiring information on coordinates in the display areas of respective ones of the plurality of display devices; when display devices displaying areas in which a plurality of pieces of drawing information acquired adjacently to each other in time are respectively superposed on contents are arranged adjacently to each other, determining whether or not there exists an operator's intention of continuity between the plurality of pieces of drawing information; if the intention of continuity between the plurality of pieces of drawing information is determined to exist, correcting the plurality of pieces of drawing information to become continuous with each other; and redisplaying, on the plurality of display devices regarded as a single display area, the plurality of drawing information after the correction along with the contents in a display mode where the former are superposed on the latter.

An information processing program of the present invention causing a computer to execute: a contents acquisition process of acquiring contents; an arrangement configuration acquisition process of acquiring an arrangement configuration of a plurality of display devices; a contents output process of displaying the contents by regarding the plurality of display devices as a single display area, on the basis of the arrangement configuration; a drawing information acquisition process of acquiring drawing information to be displayed along with currently displayed contents in a display mode where the former is superposed on the latter, with respect to each of the plurality of display devices, via an input device for acquiring information on coordinates in the display areas of respective ones of the plurality of display devices; a continuity determination process of, when display devices displaying areas in which a plurality of pieces of drawing information acquired adjacently to each other in time are respectively superposed on contents are arranged adjacently to each other, determining whether or not there exists an operator's intention of continuity between the plurality of pieces of drawing information; a drawing information correction process of, if the intention of continuity between the plurality of pieces of drawing information is determined to exist, correcting the plurality of pieces of drawing information to become continuous with each other; and a redisplay process of redisplaying, on the plurality of display devices regarded as a single display area, the drawing information after the correction along with the contents in a display mode where the former are superposed on the latter.

### Advantageous Effects of Invention

The present invention can provide, with respect to an information processing device which displays contents in a manner to extend them across a plurality of display devices, an information processing device which can improve continuity of drawing information inputted in a manner to extend continuously across the plurality of display devices.

### BRIEF DESCRIPTION OF DRAWINGS

FIG. 1A is a schematic diagram for explaining a subject of the present invention.

FIG. 1B is another schematic diagram for explaining the subject of the present invention.

FIG. 2 is a hardware configuration diagram of an information processing device as a first exemplary embodiment of the present invention.

FIG. 3 is a functional block diagram of the information processing device as the first exemplary embodiment of the present invention.

FIG. 4 is a diagram showing an example of acquisition by an arrangement configuration acquisition unit in the first exemplary embodiment of the present invention.

FIG. 5 is a diagram showing an example of a data configuration of drawing information in the first exemplary embodiment of the present invention.

FIG. 6 is a diagram showing an example of determination by a continuity determination unit in the first exemplary embodiment of the present invention.

FIG. 7 is a diagram showing an example of correction by a drawing information correction unit in the first exemplary embodiment of the present invention.

FIG. 8 is a flow chart illustrating outlined operation of the information processing device as the first exemplary embodiment of the present invention.

FIG. 9 is a flow chart illustrating continuity determination operation of the information processing device as the first exemplary embodiment of the present invention

FIG. 10 is a block diagram showing a configuration of an information processing system as a second exemplary embodiment of the present invention.

FIG. 11 is a hardware configuration diagram of the information processing system as the second exemplary embodiment of the present invention.

FIG. 12 is a functional block diagram of the information processing system as the second exemplary embodiment of the present invention.

FIG. 13 is a flow chart illustrating operation of the information processing system as the second exemplary embodiment of the present invention.

FIG. 14 is a diagram showing an example of a data configuration of drawing information in the second exemplary embodiment of the present invention.

FIG. 15 is a block diagram showing a configuration of an information processing system as a third exemplary embodiment of the present invention.

FIG. 16 is a hardware configuration diagram of the information processing system as the third exemplary embodiment of the present invention.

FIG. 17 is a functional block diagram of the information processing system as the third exemplary embodiment of the present invention.

FIG. 18 is a flow chart illustrating outlined operation of the information processing system as the third exemplary embodiment of the present invention.

FIG. 19 is a flow chart illustrating continuity determination operation of the information processing system as the third exemplary embodiment of the present invention.

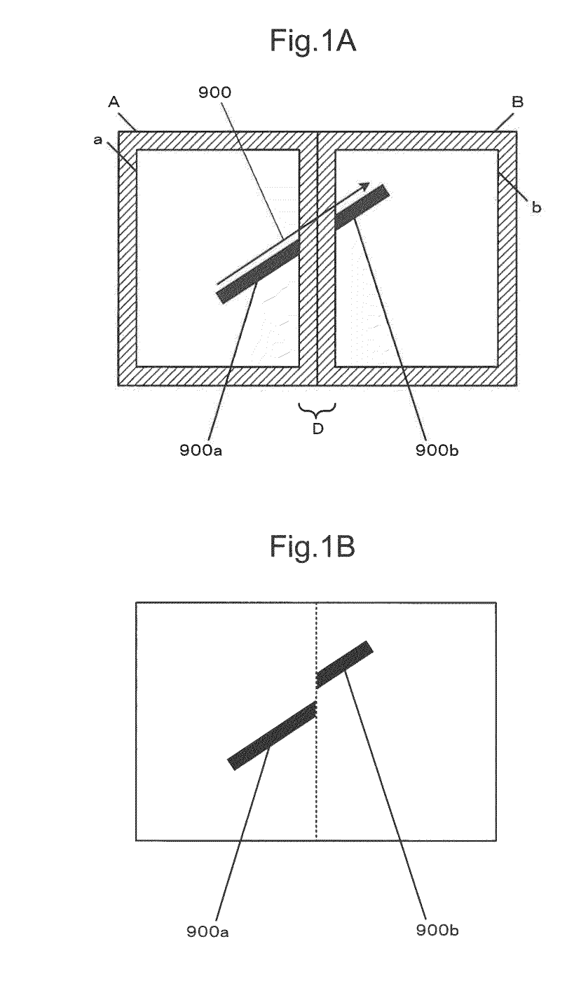

### DESCRIPTION OF EMBODIMENTS

Hereinafter, exemplary embodiments of the present invention will be described in detail with reference to drawings.

### First Exemplary Embodiment

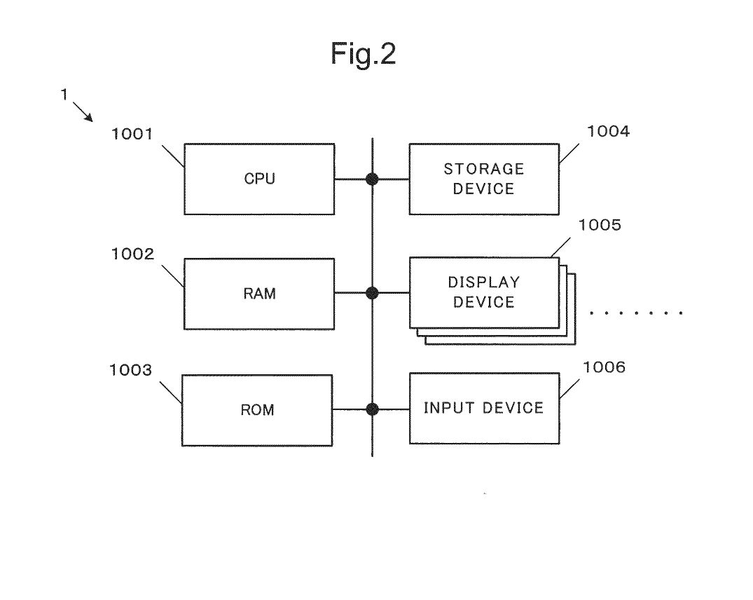

A hardware configuration of an information processing device 1 as a first exemplary embodiment of the present invention is shown in FIG. 2. In FIG. 2, the information processing device 1 consists of a computer system including a CPU (Central Processing Unit) 1001, a RAM (Random Access Memory) 1002, a ROM (Read Only Memory) 1003, a storage device 1004 such as a hard disk, a plurality of display devices 1005 and an input device 1006.

The CPU 1001 reads computer program modules and data stored in the storage device 1004 and in the ROM 1003 into the RAM 1002, and then executes them.

The storage device 1004 and the ROM 1003 store various computer program modules and various data for enabling the computer system to function as the information processing device of the present invention. The storage device 1004 stores contents which are to be displayed on the display devices 1005, as necessary.

The plurality of display devices 1005 are each composed of, for example, a liquid crystal display or the like, and they each display an image processed by the CPU 1001.

The input device 1006 acquires information on coordinates in the display areas of respective ones of the plurality of display devices 1005. For example, the input device 1006 may be composed of a plurality of touch panels which are integrated with respective ones of the display devices 1005. Alternatively, the input device 1006 may be composed of a mouse which can acquire information on coordinates in the display area of each and every one of the display devices 1005.

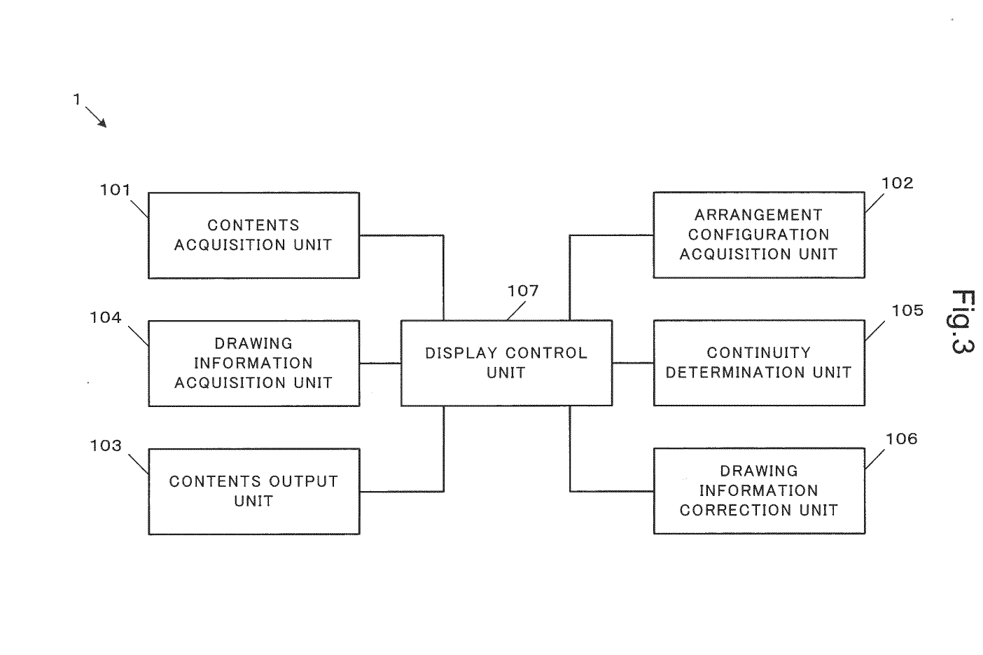

Next, a functional block configuration of the information processing device 1 is shown in FIG. 3. In FIG. 3, the information processing device 1 includes a contents acquisition unit 101, an arrangement configuration acquisition unit 102, a contents output unit 103, a drawing information acquisition unit 104, a continuity determination unit 105, a drawing information correction unit 106 and a display control unit 107. Here, the contents acquisition unit 101 and the drawing information acquisition unit 104 are composed of the input device 1006 and of the CPU 1001 which reads computer program modules and data stored in the ROM 1003 or in the storage device 1004 into the RAM 1002 and then executes them. The arrangement configuration acquisition unit 102 and the contents output unit 103 are composed of the display devices 1005 and of the CPU 1001 which reads computer program modules and data stored in the ROM 1003 or in the storage device 1004 into the RAM 1002 and then executes them. The continuity determination unit 105, the drawing information correction unit 106 and the display control unit 107 also are composed of the CPU 1001 which reads computer program modules and data stored in the ROM 1003 or in the storage device 1004 into the RAM 1002 and then executes them. Here, hardware configurations of the respective functional blocks of the information processing device 1 are not limited to the above-described ones.

The contents acquisition unit 101 acquires information representing contents. For example, the contents acquisition unit 101 may display a contents list on the display devices 1005 and acquire information representing contents selected by a user via the input device 1006. Alternatively, the contents acquisition unit 101 may create information representing blank contents newly and acquire it.

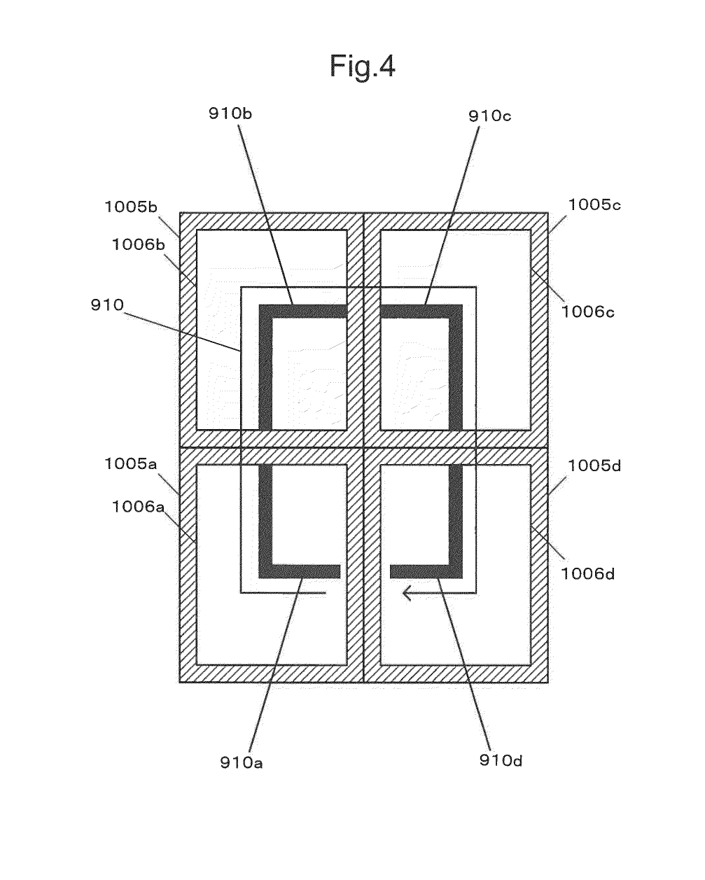

The arrangement configuration acquisition unit 102 acquires information representing an arrangement configuration of the plurality of display devices 1005. Specifically, the arrangement configuration acquisition unit 102 acquires information representing the number of display devices included in the plurality of display devices 1005, a physical positional relationship between them or the like. For example, the arrangement configuration acquisition unit 102 may acquire information representing an arrangement configuration stored in advance in the ROM 1003 or the storage device 1004. Alternatively, the arrangement configuration acquisition unit 102 may acquire information representing an arrangement configuration via the input device 1006. For example, the arrangement configuration acquisition unit 102 may acquire information representing an arrangement configuration by a user's inputting drawing information by a single stroke extending across a plurality of display devices. In the present case, it is assumed that display areas of respective ones of the plurality of display devices 1005 are each rectangular, and they are arranged in a grid pattern. Here, FIG. 4 shows an example of arrangement configuration acquisition based on drawing information inputted by a single stroke. For example, it is assumed that four display devices 1005a to 1005d are arranged as shown in FIG. 4. Also assumed is that, in FIG. 4, touch panels 1006a to 1006d are provided such that they are integrated with the display areas of respective ones of the four display devices 1005a to 1005d. In this case, the arrangement configuration acquisition unit 102 may acquire, via the touch panels 1006a to 1006d, pieces of drawing information 910a to 910d given by a stroke 910 which is a single stroke drawing passing through each of the display areas of the four display devices 1005a to 1005d. Also in this case, the arrangement configuration acquisition unit 102 may acquire information representing an arrangement configuration of the plurality of display devices 1005, on the basis of an order of acquiring the pieces of drawing information 910a to 910d given by the single stroke drawing and on the basis of relative positions of the start point and end point of each of the pieces of drawing information 910a to 910d with respect to the four sides of the (whole) display area.

On the basis of the arrangement configuration acquired by the arrangement configuration acquisition unit 102, the contents output unit 103 displays contents on the plurality of display devices 1005 by regarding them as a single display area. Specifically, on the basis of the number of display devices included in the plurality of display devices 1005, a positional relationship between them and the resolution of each display area, the contents output unit 103 determines a coordinate range of the total display area composed of the plurality of display areas. Then, of thus determined coordinate range of the total display area, the contents output unit 103 may determine coordinate ranges to be assigned to respective ones of the display devices 1005.

On thus determined single display area composed of the plurality of display devices 1005, the contents output unit 103 displays contents according to control by the display control unit 107, which will be described later. Here, the contents treated as display subject by the contents output unit 103 are those notified from the display control unit 107. Further, also according to control by the display control unit 107, the contents output unit 103 performs various kinds of processes on currently displayed contents and redisplays the result on the single display area composed of the plurality of display devices 1005. The various kinds of processes include, for example, processes with respect to the contents such as of superposing drawing information, changing display magnification and changing display positions.

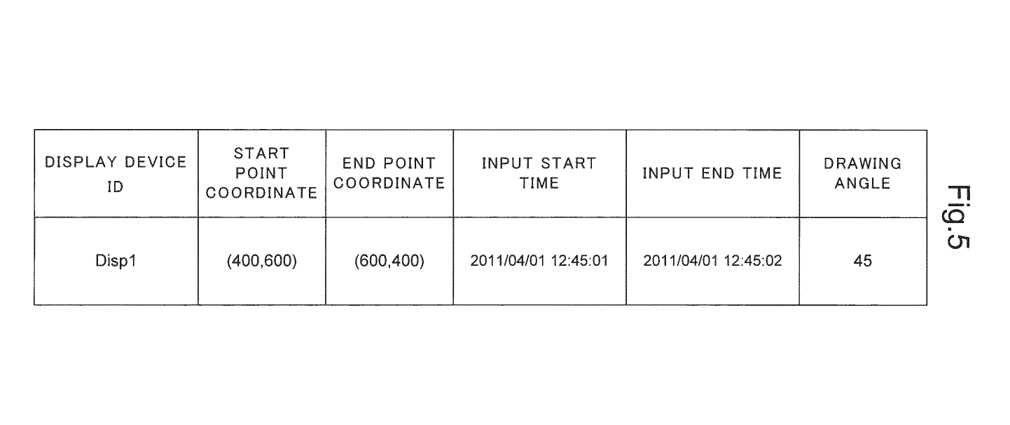

The drawing information acquisition unit 104 acquires, with respect to each of the display devices 1005, drawing information to be displayed in a manner to superpose it on the currently displayed contents, via the input device 1006. Here, the drawing information is constituted to include coordinate information acquired from the input device 1006. For example, the drawing information may include, as shown in FIG. 5, identification information on the display device 1005 displaying the area in which the drawing information is to be superposed, coordinates of the start point and the end point, the start time and the end time of the input operation, and the drawing angle. Here, the drawing information shown in FIG. 5 is an example of a case of representing a straight line. For example, in a case of a free-form curve, drawing information may further include a temporal sequence of coordinate information representing a locus. Further, drawing information may include, not just the drawing angle, other information obtained also from the drawing information such as the drawing speed.

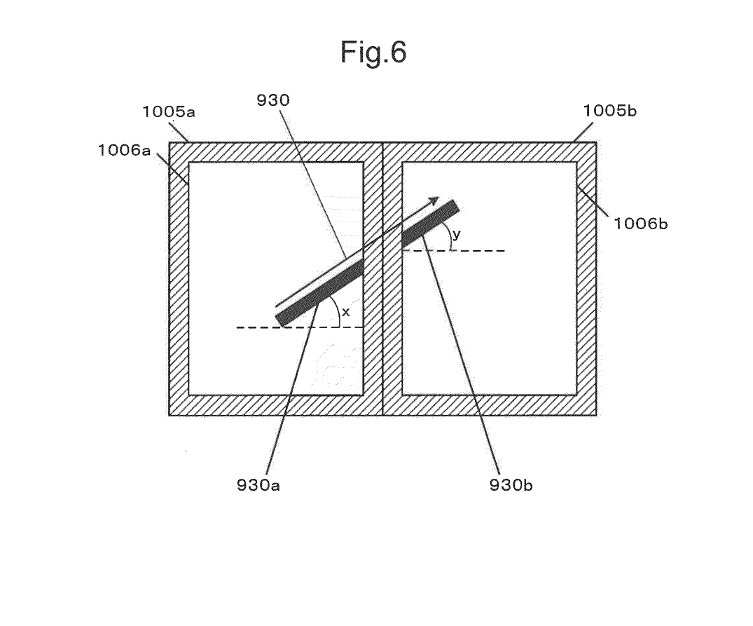

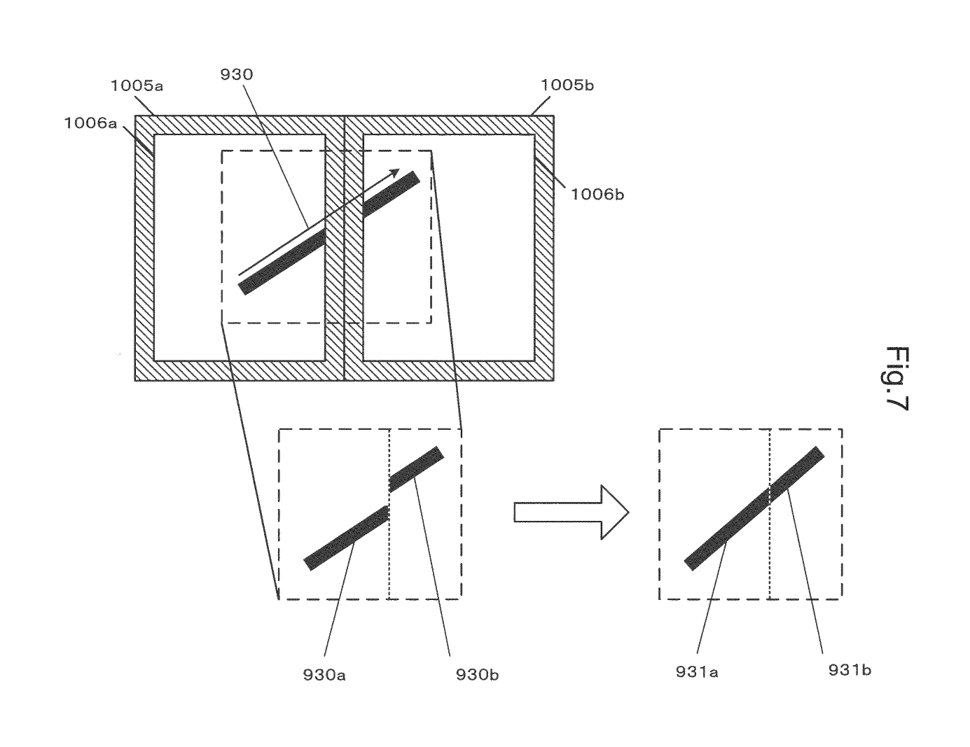

For example, a description will be given of an example of a case where, as shown in FIG. 6, the input device 1006 is composed of touch panels provided on the display areas of respective ones of the display devices 1005a and 1005b. Here, it is assumed that an operator performs a drag operation with a single stroke 930 extending across the touch panels 1006a and 1006b using his/her finger or a touch pen. In that case, the drawing information acquisition unit 104 acquires drawing information 930a via the touch panel 1006a, and subsequently acquires drawing information 930b via the touch panel 1006b.

When display devices displaying areas in which a plurality of pieces of drawing information acquired adjacently to each other in time are superposed respectively are arranged adjacently to each other, the continuity determination unit 105 determines whether or not there exists an operator's intention of continuity between the plurality of pieces of drawing information. Here, the plurality of pieces of drawing information acquired adjacently to each other in time are defined as pieces of drawing information adjacent to each other, among those acquired by the drawing information acquisition unit 104, when all of the acquired ones are lined up in a temporal order. Here, taking into consideration a case of a plurality of operators' performing operation simultaneously and that of a single operator's performing touch operation with a plurality of fingers or the like, the continuity determination unit 105 may extract such pieces of drawing information adjacent to each other from pieces of drawing information lined up in a temporal order with respect to each operator or each touch medium. The continuity determination unit 105 may determine the presence or absence of intention of continuity not just between two pieces of drawing information but also between three or more pieces of drawing information. In that case, for example, when the lately acquired one of two pieces of drawing information having been determined to be given the intention of continuity and another piece of drawing information further acquired just subsequently to the drawing information are those acquired respectively in display devices 1005 arranged adjacently to each other, the continuity determination unit 105 may further determine the presence or absence of intention of continuity between them. If determining the intention of continuity between the two pieces of drawing information to exist, the continuity determination unit 105 may determine that there exists the intention of continuity between the three sequentially acquired pieces of drawing information where, in addition to the two pieces of drawing information for which the intention of continuity was previously determined to exist, the one acquired subsequently to them is included.

The continuity determination unit 105 may determine whether or not there exists the operator's intention of continuity between such a plurality of drawing information from the acquisition time, drawing angle, drawing speed or the like of each of the pieces of drawing information. For example, when the time interval from the input end time of a certain piece of drawing information to the input start time of another piece of drawing information subsequently acquired at a neighbor display device 1005 is equal to or smaller than a threshold value, the continuity determination unit 105 may determine the intention of continuity to exist. Here, the input start time and the input end time of a certain piece of drawing information are referred to as times at which a coordinate being the start point and that being the end point are acquired, respectively, which are determined on the basis of the drawing direction of the drawing information. The threshold value of the time interval may be determined in advance on the basis of the distance between the display areas of respective ones of the two corresponding display devices 1005. The threshold value of the time interval may also be dynamically calculated taking the drawing angle of drawing information into consideration.

The continuity determination unit 105 may also determine the intention of continuity to exist when the distance from the end point coordinate of a certain piece of drawing information to the start point coordinate of another piece of drawing information subsequently acquired at a neighbor display device 1005 is equal to or smaller than a threshold value. The continuity determination unit 105 may also determine the presence or absence of the intention of continuity on the basis of respective drawing angles of a plurality of pieces of drawing information. In that case, the continuity determination unit 105 may determine the intention of continuity to exist when the difference between the drawing angle of a certain piece of drawing information and that of another piece of drawing information subsequently acquired at a neighbor display device 1005 is equal to or smaller than a threshold value. The continuity determination unit 105 may also determine the presence or absence of the intention of continuity on the basis of respective drawing speeds of a plurality of pieces of drawing information. In that case, the continuity determination unit 105 may determine the intention of continuity to exist when the difference between the drawing speed of a certain piece of drawing information and that of another piece of drawing information subsequently acquired at a neighbor display device 1005 is equal to or smaller than a threshold value. Here, the continuity determination unit 105 may determine the presence or absence of intention of continuity on the basis of, not just the above-mentioned time interval, distance between start and end points, drawing angle and drawing speed, but also other various kinds of information obtained from each piece of drawing information, such as their colors, thicknesses or the like. Further, the continuity determination unit 105 may determine the presence or absence of intention of continuity on the basis of a combination of these various kinds of information obtained from each piece of drawing information. For example, the continuity determination unit 105 may determine the intention of continuity to exist when the time interval from the input end time of a certain piece of drawing information to the input start time of another piece of drawing information subsequently acquired at a neighbor display device 1005 is equal to or smaller than a threshold value and also the difference in drawing angle between the two pieces of drawing information is equal to or smaller than a threshold value.

For example, the description will be continued below, assuming that, as shown in FIG. 6, the pieces drawing information 930a and 930b have been acquired adjacently to each other in time in this order. In this case, the continuity determination unit 105 determines that the display devices 1005a and 1005b on which the pieces of drawing information 930a and 930b are respectively displayed in a superposed display mode are arranged adjacently to each other. Then, if the time interval from the input end time of the drawing information 930a to the input start time of the drawing information 930b is equal to or smaller than a threshold value and also the difference between a drawing angle x of the drawing information 930a and a drawing angle y of the drawing information 930b is also equal to or smaller than a threshold value, the continuity determination unit 105 may determine that there exists the operator's intention of continuity between the pieces of drawing information 930a and 930b.

If it is determined that there exists the intention of continuity between the above-mentioned plurality of drawing information, the drawing information correction unit 106 corrects these plurality of drawing information to become continuous with each other. For example, when it has been determined that there exists continuity between the pieces of drawing information 930a and 930b shown in FIG. 6, the drawing information correction unit 106 may correct these pieces of drawing information 930a and 930b into pieces of drawing information 931a and 931b, respectively, such that the corrected pieces of drawing information collectively represent a straight line from the start point of the drawing information 930a to the end point of the drawing information 930b.

When there are three or more pieces of drawing information between which the intention of continuity has been determined to exist, the drawing information correction unit 106 may correct each of these three or more pieces of drawing information on the basis of them. For example, if the three or more pieces of drawing information each represent a straight line, the drawing information correction unit 106 may correct each of the pieces of drawing information such that they collectively represent a straight line from the start point of the firstly acquired drawing information to the end point of the lastly acquired drawing information. Alternatively, even in such a case where there are three or more pieces of drawing information between which the intention of continuity has been determined to exist, the drawing information correction unit 106 may sequentially correct each two pieces of drawing information neighboring each other to become continuous with each other.

Further, not just when pieces of drawing information between which the intention of continuity has been determined to exist each represent a straight line but also when they each represent another shape, the drawing information correction unit 106 may correct them to become continuous with each other. For example, when such pieces of drawing information each represent a free-form curve, the drawing information correction unit 106 may extract the coordinates constituting the plurality of pieces of drawing information at predetermined intervals and then correct each of the pieces of drawing information such that they collectively represent an approximate curve passing through the extracted coordinates.

The display control unit 107 controls display contents outputted by the contents output unit 103. Specifically, by notifying the contents output unit 103 of contents acquired by the contents acquisition unit 101, the display control unit 107 controls the contents output unit 103 to display the acquired contents. The display control unit 107 also controls the contents output unit 103 to redisplay drawing information corrected by the drawing information correction unit 106 in a display mode where it is superposed on currently displayed contents.

Here, before controlling the contents output unit 103 to redisplay the corrected drawing information, the display control unit 107 may control it to display information for inquiring whether the content of the correction is in agreement with the operator's intention. In that case, if acquiring information expressing agreement with the operator's intention via the input device 1006, the display control unit 107 controls the contents output unit 103 to redisplay the corrected drawing information. On the other hand, if acquiring information expressing disagreement with the operator's intention, the display control unit 107 may control the contents output unit 103 redisplay the drawing information without correction. Alternatively, if acquiring information expressing disagreement with the operator's intention, the display control unit 107 may acquire information representing an adjustment of the content of the correction via an input device 1006. In that case, the display control unit 107 may then control the contents output unit 103 to redisplay drawing information reflecting the content of the correction having been adjusted according to the acquired information.

Further, the display control unit 107 controls the contents output unit 103 to redisplay drawing information which is not adjacent in time to any other drawing information and redisplay drawing information which, while being adjacent in time to some other drawing information, has not been determined to have continuity with the other drawing information, in a display mode where they are superposed on the currently displayed contents.

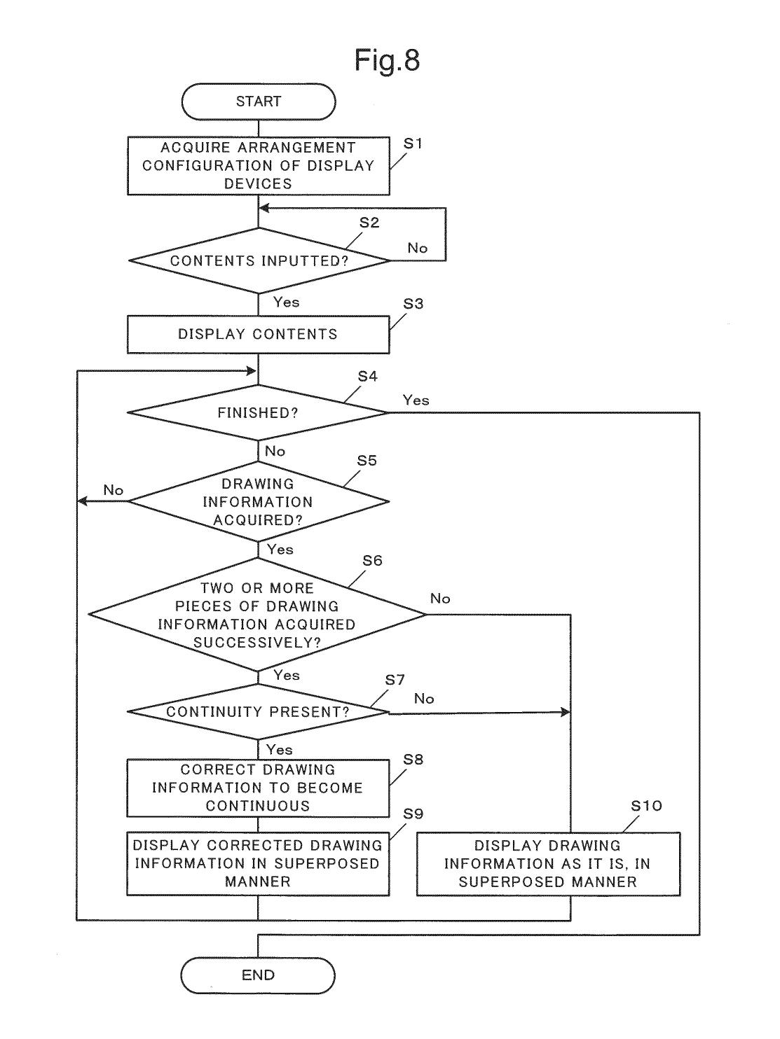

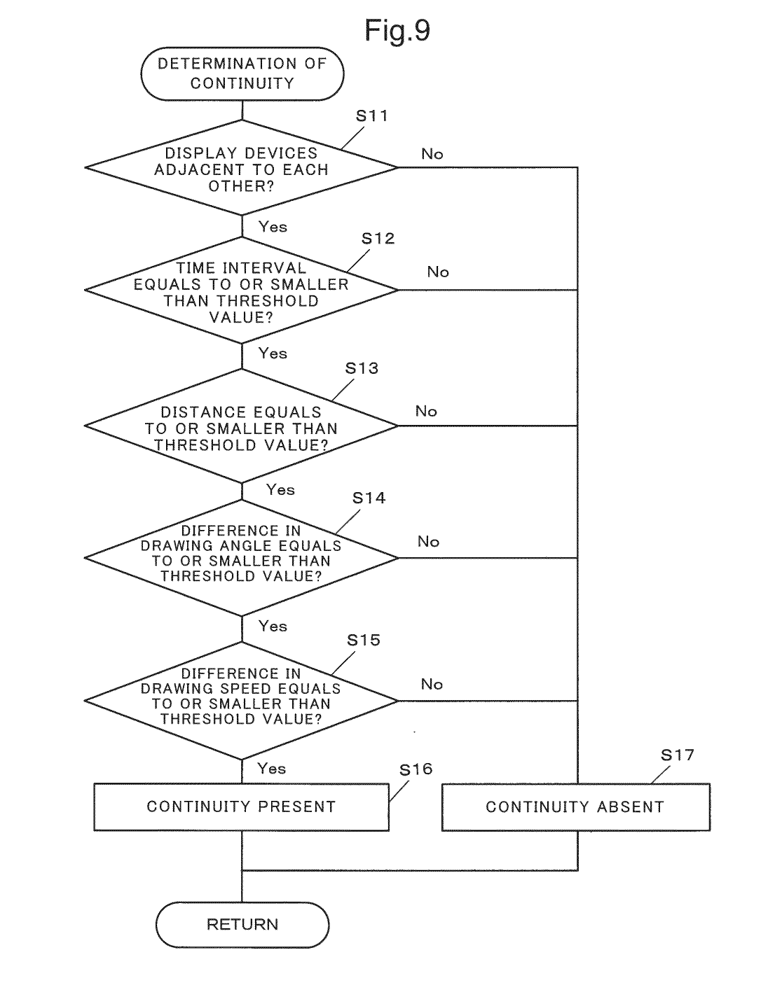

Hereinafter, a description will be given of operation of the information processing device 1 configured as above, with reference to FIGS. 8 and 9.

First, the arrangement configuration acquisition unit 102 acquires information representing an arrangement configuration of the plurality of display devices 1005 (step S1). The present description will be given of, for example, a case where a plurality of touch panels are provided on respective ones of the plurality of display devices 1005, as the input device 1006, as already described above. In this case, the configuration acquisition unit 102 may acquire information representing an arrangement configuration of the plurality of display devices 1005 including the number of devices included in them and their mutual positional relationship, by acquiring a touch operation with a single stroke extending across the plurality of touch panels.

Next, the contents acquisition unit 101 acquires information representing contents (Yes at step S2). For example, the contents acquisition unit 101 may acquire information representing contents which has been selected by the input device 1006 from a contents list displayed on the display devices 1005. This information representing contents may be, for example, a file path or the like which indicates the storage location of the contents. If finding that the contents represented by the acquired information are not stored at the indicated storage location (No at step S2), the contents acquisition unit 101 may notify the user of the absence of the contents and execute the step S2 again. If acquiring information representing an instruction to create new contents, the contents acquisition unit 101 may create new contents such as blank images and thereby acquire information representing the new contents thus created.

Next, the display control unit 107 notifies the contents output unit 103 to output the contents represented by the information acquired in the step S2 to the display devices 1005. Then, the contents output unit 103 displays the contents on the plurality of display devices 1005, treating them as a single display area, by allocating display areas for displaying the contents to the respective display devices 1005 on the basis of the arrangement configuration acquired in the step S1 (step S3).

Next, the drawing information acquisition unit 104 determines whether or not it has acquired information representing an instruction to finish the process via the input device 1006 (step S4). If the information representing an instruction to finish is acquired, the information processing device 1 ends the process. If the information has not been acquired, the operation of the information processing device 1 proceeds to a step S5.

Next, the drawing information acquisition unit 104 determines whether or not it has acquired drawing information via the input device 1006 (step S5). If no drawing information has been acquired, the operation of the information processing device 1 returns to the step S4.

On the other hand, if the continuity determination unit 105 determines in the step S5 that drawing information has been acquired, it further determines whether or not it has acquired a further piece of drawing information subsequently (step S6).

For example, if it acquires a further piece of drawing information before the elapse of a predetermined time period after determining to have acquired a piece of drawing information in the step S5, the continuity determination unit 105 may determine to have acquired the pieces of drawing information continuously.

Here, when it has determined to have acquired the pieces of drawing information continuously, if the first drawing information acquired in the step S5 and the second drawing information acquired in the step S6 are those acquired at display devices 1005 arranged adjacently to each other, the continuity determination unit 105 determines whether or not there exists the operator's intention of continuity between the first and second drawing information (step S7). Details of the operation in the step S7 will be descried later.

If, in the step S7, the continuity determination unit 105 determines the operator's intention of continuity to exist between the first and second drawing information, the drawing information correction unit 106 corrects these two pieces of drawing information to become continuous with each other (step S8).

Next, the display control unit 107 controls the contents output unit 103 to redisplay the contents on which the first and second drawing information having received the correction are superposed (step S9).

On the other hand, if, in the step S7, the continuity determination unit 105 determines the operator's intention of continuity to be absent between the two pieces of drawing information, the display control unit 107 controls the contents output unit 103 to redisplay the contents on which the first and second drawing information without correction are superposed (step S10).

Also in the case the continuity determination unit 105 determines, in the step S6, that no further piece of drawing information has been subsequently acquired, the display control unit 107 executes the step S10 and thus controls the contents output unit 103 to redisplay the contents on which the drawing information acquired in the step S5 is superposed.

Then, the operation of the information processing device 1 returns to the step S4.

With that, the description of outlined operation of the information processing device 1 is finished.

Next, details of the operation in the step S7 will be described with reference to FIG. 9. Here, it is assumed that the first and second drawing information each represent a straight line.

First, on the basis of the arrangement configuration acquired in the step S1, the continuity determination unit 105 determines whether or not a display device 1005 displaying the area for the contents on which the first drawing information is superposed and the other display device 1005 displaying the area for the contents on which the second drawing information is superposed are arranged adjacently to each other (step S11).

If determining here these display devices 1005 to be arranged adjacently to each other, the continuity determination unit 105 then determines whether or not the time interval between the input end time of the first drawing information and the input start time of the second drawing information is equal to or smaller than a threshold value (step S12).

Here, if using, for the threshold value in this step, the same value as that of the threshold value used in the step S6, this step does not necessarily need to be executed.

If determining here the time interval to be equal to or smaller than the threshold value, the continuity determination unit 105 then determines whether or not the distance between the end point coordinate of the first drawing information and the start point coordinate of the second drawing information is equal to or smaller than a threshold value (step S13).

If determining here the distance to be equal to or smaller than the threshold value, the continuity determination unit 105 then determines whether or not the difference between the drawing angle of the first drawing information and that of the second drawing information is equal to or smaller than a threshold value (step S14).

If determining here the difference in drawing angle to be equal to or smaller than the threshold value, the continuity determination unit 105 then determines whether or not the difference between the drawing speed of the first drawing information and that of the second drawing information is equal to or smaller than a threshold value (step S15).

If determining here the difference in drawing speed to be equal to or smaller than the threshold value, the continuity determination unit 105 determines that there exists the operator's intention of continuity between the first and second drawing information (step S16).

On the other hand, if determining in the step S11 that the corresponding display devices are not arranged adjacently to each other, or if determining in any of the steps S12 to S15 that the corresponding evaluation value is larger than the corresponding threshold value, the continuity determination unit 105 determines that there does not exist the operator's intention of continuity between the first and second drawing information (step S17).

With that, the description of the continuity determination operation in the step S7 is finished.

In the step S6 in FIG. 8, the continuity determination unit 105 may acquire three or more pieces of drawing information as a plurality of continuous pieces of drawing information, by sequentially acquiring drawing information until no subsequent drawing information is acquired before the elapse of a predetermined time period since acquisition of a piece of drawing information.

In that case, the continuity determination unit 105 may determine whether or not there exists the intention of continuity between the three or more pieces of drawing information by executing the steps S11 to S17 in FIG. 9 on each two pieces of drawing information adjacent to each other in time.

Also in that case, the drawing information correction unit 106 may correct some pieces of drawing information, among the sequentially acquired plurality of pieces of drawing information, which have been determined to be given the intention of continuity and thus extracted, to become continuous with each other. Then, the display control unit 107 controls the contents output unit 103 to redisplay the corrected drawing information in a display mode where it is superposed. The display control unit 107 may further control the contents output unit 103 to display in a superposed manner the rest of the sequentially acquired plurality of pieces of drawing information, which have been determined not to be given the intention of continuity, with no correction

Next, the effect of the first exemplary embodiment of the present invention will be described.

The information processing device 1 as the first exemplary embodiment of the present invention can improve, in displaying contents in a manner to extend them across a plurality of display devices 1005, continuity of drawing information inputted in a manner to extend it continuously across a plurality of display devices 1005.

It is because, when display devices displaying areas in which a plurality of pieces of drawing information acquired adjacently to each other in time are respectively superposed are arranged adjacently to each other, the continuity determination unit 105 determines whether or not there exists an operator's intention of continuity between the plurality of pieces of drawing information and, if there exists the intention of continuity, the drawing information correction unit 106 corrects these pieces of drawing information to be continuous with each other.

Because the information processing device 1 as the first exemplary embodiment of the present invention thereby corrects the pieces of drawing information extending across a plurality of display devices 1005 to become continuous and superposes them after the correction, even when scrolling, display magnification change or the like causes change in display positions of the contents and the pieces of drawing information extending across the plurality of display devices 1005 consequently come to be displayed on a single display device 1005, discontinuous displaying of the pieces drawing information can be prevented. Further, the information processing device 1 as the first exemplary embodiment of the present invention can prevent that pieces of drawing information inputted in a manner to extend continuously across a plurality of display devices 1005 are discontinuously displayed in another device whose display devices are different from those in the information processing device 1 in resolution, number and arrangement configuration.

### Second Exemplary Embodiment

Next, a second exemplary embodiment of the present invention will be described in detail, with reference to drawings. In this second exemplary embodiment of the present invention, a description will be given of an information processing system 2 in which information processing devices display contents which are shared between them. Here, in each of drawings referred to in the description of the present exemplary embodiment, to the same constituents and steps with the same operations as those in the first exemplary embodiment of the present invention, respective same reference signs as that in the first exemplary embodiment are given, and their detail descriptions are omitted here.

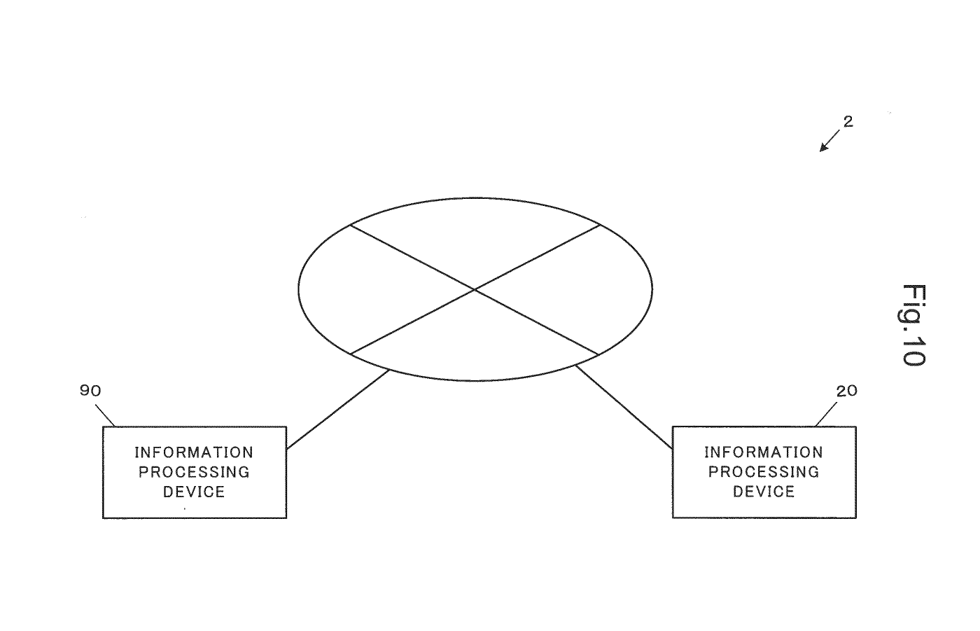

First, a configuration of the information processing system 2 as the second exemplary embodiment of the present invention is shown in FIG. 10. In FIG. 10, the information processing system 2 includes an information processing device 20 and another information processing device 90. Here, the information processing devices 20 and 90 are connected with each other in a manner to enable mutual communication via a network which is constructed by the internet, a LAN (Local Area Network), a public line network, a wireless communication network or a combination of them. Although the configuration in FIG. 10 includes only one information processing device 20 and one information processing device 90, there is no restriction on the number of information processing devices 20 and 90 included in the information processing system of the present invention.

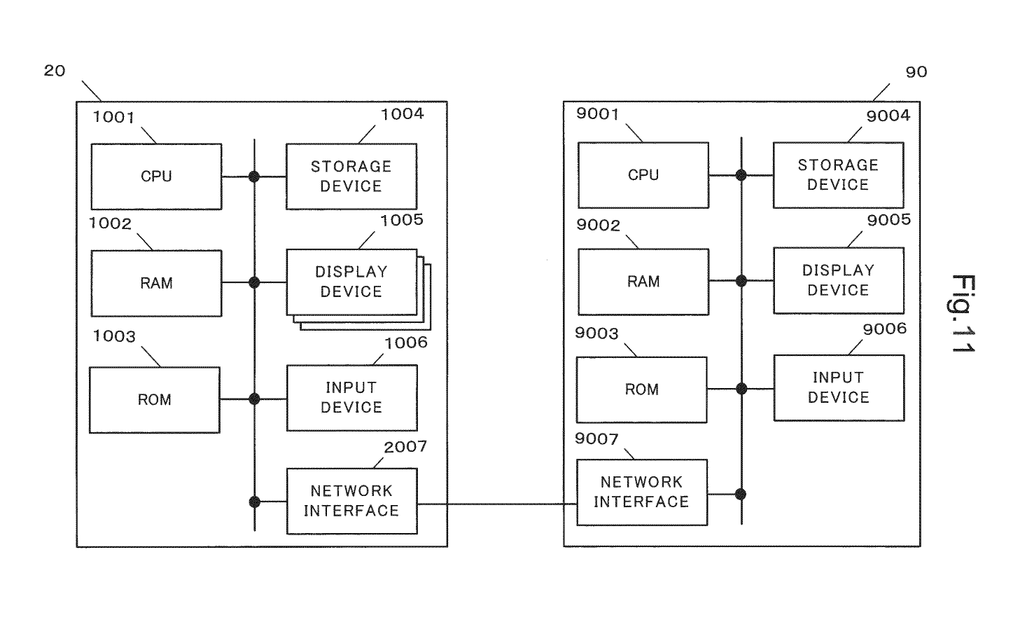

Hardware configurations of the information processing devices 20 and 90 are shown in FIG. 11. In FIG. 11, the information processing device 20 includes a network interface 2007 in addition to the same hardware configuration as that of the information processing device 1 as the first exemplary embodiment of the present invention. The information processing device 90 consists of a computer system including a CPU 9001, a RAM 9002, a ROM 9003, a storage device 9004 such as a hard disk, a display device 9005, an input device 9006 and a network interface 9007. Network interfaces 2007 and 9007 each are an interface for communicating with the other one of the information processing devices via a network. The input device 9006 is a device capable of acquiring information on coordinates in the display area of the display device 9005. For example, the input devices 9006 may be a touch panel integrated with the display device 9005.

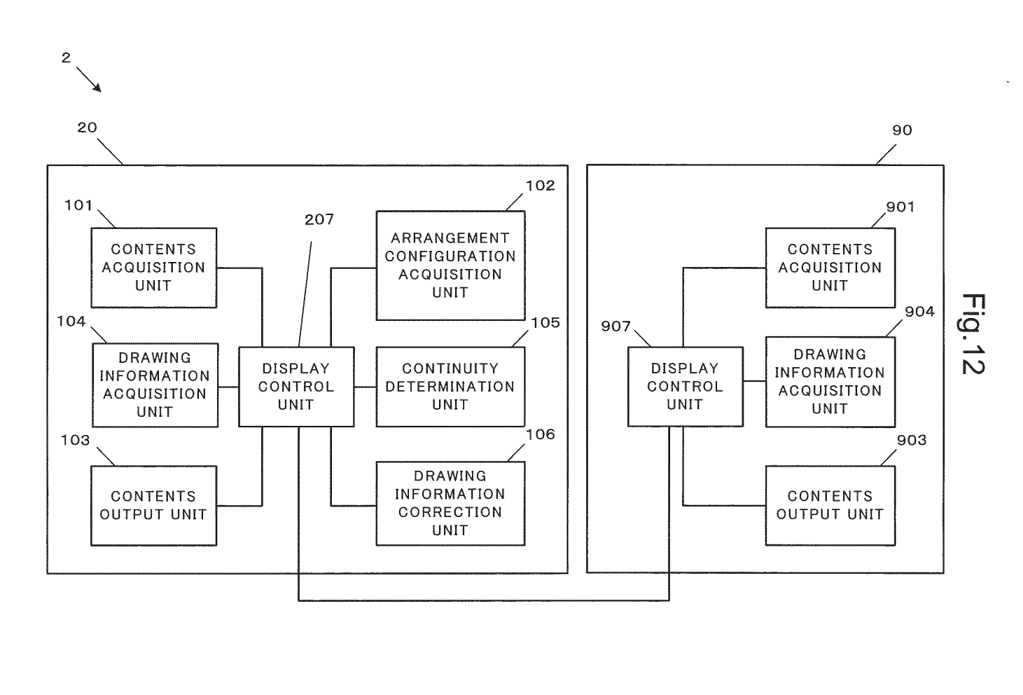

Next, function blocks of the information processing devices 20 and 90 are shown in FIG. 12. In FIG. 12, the information processing device 20 is different from the information processing device 1 as the first exemplary embodiment of the present invention in that it includes a display control unit 207 in place of the display control unit 107.

The display control unit 207 is configured similarly to the display control unit 107 in the first exemplary embodiment of the present invention and thereby controls the contents output unit 103 to output contents, drawing information and drawing information having received correction. In addition, the display control unit 207 sends contents acquired by the contents acquisition unit 101 to the information processing device 90. Further, the display control unit 207 notifies the contents output unit 103 to display contents received from the information processing device 90. The display control unit 207 also sends drawing information to the information processing device 90. The drawing information to be sent by the display control unit 207 is that acquired by the drawing information acquisition unit 104 or that corrected by the drawing information correction unit 106. The display control unit 207 also notifies the contents output unit 103 to redisplay the contents in a display mode where drawing information received from the information processing device 90 is superposed on the contents.

Next, functional blocks of the information processing device 90 will be described. In FIG. 12, the information processing device 90 includes a contents acquisition unit 901, a contents output unit 903, a drawing information acquisition unit 904 and a display control unit 907.

The contents acquisition unit 901 is configured similarly to the contents acquisition unit 101 included in the information processing device 20.

The contents output unit 903 displays contents notified from the display control unit 907 on the display device 9005. The contents output unit 903 also redisplays drawing information notified from the display control unit 907 along with currently displayed contents in a display mode where the former is superposed on the latter.

The drawing information acquisition unit 904 acquires drawing information to be displayed in a manner to superpose it on contents currently displayed on the display device 9005, via the input device 9006.

The display control unit 907 controls contents to be displayed by the contents output unit 903. Specifically, the display control unit 907 notifies the contents output unit 903 to display contents acquired by the contents acquisition unit 901. The display control unit 907 also sends the contents acquired by the contents acquisition unit 901 to the information processing device 20. The display control unit 907 also notifies the contents output unit 903 to display contents received from the information processing device 20. The display control unit 907 also notifies the contents output unit 103 to redisplay contents in a display mode where drawing information received from the information processing device 20 is superposed on the contents.

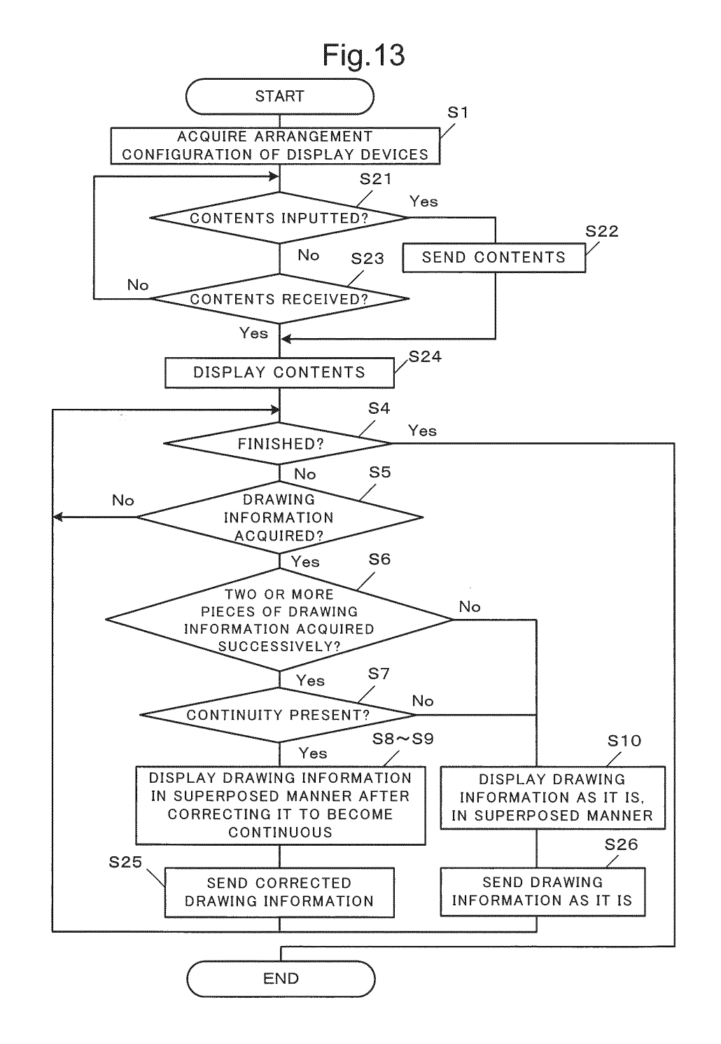

Operation of the information processing system 2 configured as above will be described with reference to FIG. 13. In FIG. 13, illustration of operation of the information processing device 90 is omitted.

First, the arrangement configuration acquisition unit 102 of the information processing device 20 acquires information representing an arrangement configuration of the display devices 1005, similarly to in the information processing device 1 as the first exemplary embodiment of the present invention (step S1).

Next, also similarly to in the information processing device 1 as the first exemplary embodiment of the present invention, the contents acquisition unit 101 of the information processing device 20 determines whether or not any input operation for designating contents has been performed (step S21).

If it is determined in the step S21 that an input operation for designating contents has been performed, the display control unit 207 sends information representing the contents to the information processing device 90 (step S22). Then, the operation of the information processing system 2 proceeds to a step S24.

On the other hand, if it is determined in the step S21 that no input operation for designating contents has been performed, the display control unit 207 determines whether or not information representing contents has been received from the information processing device 90 (step S23).

Here, if no information representing contents has been received, the operation of the information processing system 2 returns to the step S21.

On the other hand, if it is determined in the step S23 that information representing contents has been received, or if it is determined in the step S21 that an input operation for designating contents has been performed, the display control unit 207 notifies the contents output unit 103 to display the represented or designated contents on the display devices 1005 (step S24).

Also the information processing device 90, by operating in a similar way to the steps S21 to S24, displays contents acquired at itself or that received from the information processing device 20 on the display device 9005.

At this stage, the information processing devices 20 and 90 are displaying the same contents shared by them.

Next, by operating in the steps S4 to S10 similarly to the information processing device 1 as the first exemplary embodiment of the present invention, the information processing device 20 corrects acquired drawing information as necessary and redisplays it along with the contents in a display mode where the former is superposed on the latter.

Next, after executing the step S9, the display control unit 207 sends the corrected drawing information to the information processing device 90 (step S25).

Alternatively, after executing the step S10, the display control unit 207 sends the drawing information not having received the correction to the information processing device 90 (step S26).

The display control unit 907 of the information processing device 90 having received the drawing information sent in the steps S25 or S26 controls the contents output unit 903 to redisplay the received drawing information in a display mode where it is superposed on the currently displayed contents.

In this way, in cases where it is determined in the information processing device 20 that there exists the intention of continuity between pieces of drawing information inputted there sequentially, the information processing devices 20 and 90 display these pieces of drawing information having received the correction along with the contents in a display mode where the former are superposed on the latter. In cases where it is determined in the information processing device 20 that there exists no intention of continuity between pieces of drawing information inputted there sequentially, the information processing devices 20 and 90 display these pieces of drawing information as they are, along with the contents in a display mode where the former are superposed on the latter.

With that, the description of the operation of the information processing system 2 is finished.

Next, a specific description will be given of an example of operation in a case where, in the information processing system 2, tablet terminals are used as the information processing devices 20 and 90, with reference to flow charts in FIGS. 13 and 9. The tablet terminals are portable information terminals which are operated by touch operations onto the display screens. In the present case, a tablet terminal A used as the information processing device 20 has two displays each provided with a touch panel, referred to as a touch panel display, and can display contents by treating these touch panel displays as a single display area. A tablet terminal B used as the information processing device 90 has a single touch panel display, on which contents can be displayed. The present description will be continued below assuming that a user A uses the tablet terminal A, and a user B the tablet terminal B.

Here, it is assumed that, using the tablet terminals A and B, the users A and B share map contents displayed on the terminals, and the user A inputs a line drawing representing a route on a map.

In this case, first, the arrangement configuration acquisition unit 102 of the tablet terminal A acquires an arrangement configuration of the display devices 1005 held by the own device (step S1).

In the present example, the arrangement configuration acquisition unit 102 acquires information indicating that the number of touch panel displays as the display devices 1005 is two. Then, the arrangement configuration acquisition unit 102 assigns “Disp1” as the identification information of the first touch panel display and “Disp2” as that of the second touch panel display. The arrangement configuration acquisition unit 102 further acquires information indicating that the resolutions of the respective display areas of Disp1 and Disp2 are each 600×800 pixels. The arrangement configuration acquisition unit 102 further acquires a physical positional relationship between “Disp1” and “Disp2”, by the user A's inputting drawing information with a single stroke extending across the plurality of touch panel displays. Then, on the basis of the acquired physical positional relationship, the arrangement configuration acquisition unit 102 defines a coordinate range from (0,0) to (1200,800) combining the display areas of the two touch panel displays as a single display area. Then, the arrangement configuration acquisition unit 102 allocate the coordinate range from (0,0) to (600,800) to “Disp1” and the coordinate range from (600, 0) to (1200,800) to “Disp2”. Here, these pieces of coordinate information are expressed with the origin set at the upper left corner.

Next, through input operation by the user A, the contents acquisition unit 101 of the tablet terminal A acquires information representing map contents stored in the storage device 1004 (step S21).

Then, the display control unit 207 of the tablet terminal A sends the information representing map contents to the tablet terminal B (step S22).

Next, the display control unit 207 of the tablet terminal A notifies the contents output unit 103 to display the information representing map contents in the coordinate range from (0,0) to (1200,800) combining “Disp1” and “Disp2” at predetermined magnification (step S24). In the present case, the size of the map contents is assumed to be 800×400 pixels, and the display control unit 207 of the tablet terminal A performs control for displaying the map contents in the display area combining “Disp1” and “Disp2” at twofold display magnification.

Next, the display control unit 907 of the tablet terminal B displays the received information representing the map contents on the single touch panel display. In the present case, the resolution of the touch panel display held by the tablet terminal B is 800×600 pixels. Then, the display control unit 907 of the tablet terminal B controls the touch panel display to display the map contents at the same magnification to contain the whole of the map contents within its display area.

Next, using a touch pen, the user A inputs a line drawing in a manner to extend it across the two touch panel displays Disp1 and Disp2, of the tablet terminal A.

At this stage, the drawing information acquisition unit 104 of the tablet terminal A firstly acquires first drawing information via Disp1 (Yes at the step S5). Subsequently, the drawing information acquisition unit 104 of the tablet terminal A acquires second drawing information via Disp2 (Yes at the step S6).

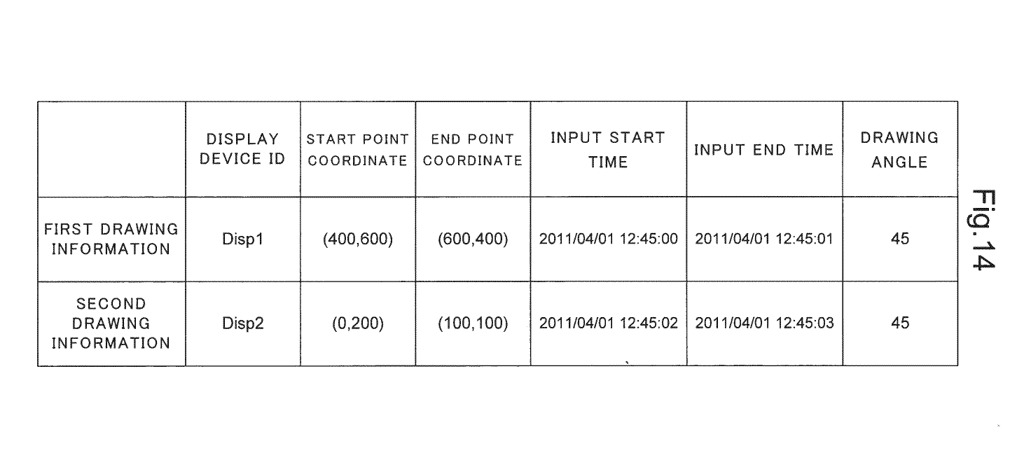

Here, the first and second drawing information each contain pieces of information shown in FIG. 14. As shown in FIG. 14, in the present example, the first and second drawing information each consist of pieces information representing respectively the display device ID, start point coordinate (X,Y), end point coordinate (X,Y), input start time, input end time and drawing angle. Here, the start point and end point coordinates contained in the two pieces of drawing information are coordinates respectively in the display area of Disp1 and that in the display area of Disp2. The drawing angle is the angle of the line connecting the start point and end point coordinates, which is obtained by calculation.

Next, the continuity determination unit 105 determines the presence or absence of the operator's intention of continuity between the first and second drawing information (step S7).

In the present example, the continuity determination unit 105 determines the intention of continuity to exist if the time interval and the difference in the drawing angle between the two pieces of drawing information are both equal to or smaller than respective threshold values. Also in the present case, in advance, the threshold value of the time interval has been set at 2 seconds, and that of the difference in the drawing angle at 10 degrees.

In this situation, the continuity determination unit 105 firstly determines that the two display devices represented by the display device IDs Disp1 and Disp2 respectively in the first and second drawing information are arranged adjacently to each other (Yes at the step S11). Then, because, referring to FIG. 14, the time interval from the input end time “12 o'clock 45 minutes 01 second on Apr. 1, 2011” of the first drawing information acquired first to the input start time “12 o'clock 45 minutes 02 second on Apr. 1, 2011” of the second drawing information acquired next is 1 second, the continuity determination unit 105 determines the time interval to be smaller than the threshold value, 2 seconds (Yes at the Step S12).

Further, the continuity determination unit 105, also referring to FIG. 14, finds the difference between the drawing angle of the first drawing information, 45 degrees, and that of the second drawing information, 45 degrees, to be 0 degree, and thereby determines the difference in the drawing angle to be smaller than the threshold value, 10 degrees (Yes at the step S14).

Accordingly, the continuity determination unit 105 determines that there exists the operator's intention of continuity between the first and second drawing information (step S16).

Next, the drawing information correction unit 106 corrects the first and second drawing information such that they are continuously displayed in the display area combining Disp1 and Disp2. In cases such as the present one, it is considered that the position of the start point of the first drawing information and that of the end point of the second drawing information are important from the viewpoint of the user A's intention given to the line drawing, and accordingly, even if the intermediate locus between the start and end points is slightly corrected, it does not cause significant departure from the user A's intention. Based upon the consideration, the drawing information correction unit 106 corrects the locus of the combination of the first and second drawing information to represent a straight line, without changing the start point of the first drawing information and the end point of the second drawing information. Specifically in the present example, the drawing information correction unit 106 corrects the end point coordinate of the first drawing information to be (600,320) and the start point coordinate of the second drawing information to be (0,320) (step S8).

Next, the display control unit 207 notifies the contents output unit 103 to redisplay the map contents in a display mode where the corrected first and second drawing information are superposed on the map contents (step S9).

Next, the display control unit 207 sends the corrected first and second drawing information to the tablet terminal B (step S25).

Then, the display control unit 907 of the tablet terminal B notifies the contents output unit 903 to redisplay the map contents in a display mode where the received pieces of drawing information are superposed on the map contents.

In this way, in the information processing system 2 as the present exemplary embodiment, when the user A inputs a line drawing extending across the two screens on the tablet terminal A, a discontinuous line drawing is never displayed on the screen of the tablet terminal B with the single screen used by the user B, but a continuous line drawing is displayed on it.

Next, the effect of the second exemplary embodiment of the present invention will be described.

The information processing system 2 as the second exemplary embodiment of the present invention can prevent that, when drawing information is inputted in a manner to extend continuously across a plurality of display devices in an information processing device which displays contents in a manner to extend them across the plurality of display devices, the drawing information is displayed discontinuously in another information processing device.

The reason will be described below.

The present description will be given of the case where, in an information processing device which is currently displaying contents on a plurality of display devices, the display devices displaying areas in which pieces of drawing information acquired adjacently to each other in time are respectively superposed are arranged adjacent to each other.

In that case, the continuity determination unit 105 determines whether or not there exists an operator's intention of continuity between these pieces of drawing information.

Then, if the continuity determination unit 105 determines the intention of continuity to exist, the drawing information correction unit 106 corrects these pieces of drawing information to become continuous with each other. Subsequently, the display control unit 207 sends the corrected drawing information to another information processing device.

Taking the above-described procedure is the reason for the capability of preventing discontinuous display.

When the other information processing device is the one which displays contents on a single display device, a plurality of pieces of drawing information inputted in a manner to extend continuously across a plurality of display devices, such as mentioned above, are displayed within the display area of the single display device of the other information processing device. In such a case, because the other information processing devices receives the drawing information corrected to become continuous, there is no possibility of its displaying discontinuous drawing information. On the other hand, when the other information processing device also is the one which displays contents by regarding a plurality of display devices as a single display area, the arrangement configuration of the display devices is not necessarily the same as that of a plurality of display devices in the information processing device at which drawing information is inputted in a manner to extend continuously across the plurality of display devices. Further, also positions and magnification for displaying contents are not necessarily the same between the two information processing devices. Accordingly, there is a possibility that, in the other information processing device, the drawing information is displayed within the display area of one of the plurality of display devices. Even in such a case, because the other information processing device receives the drawing information corrected to become continuous, there is no possibility of it's displaying discontinuous drawing information.

Further, in the information processing system 2 as the present exemplary embodiment, the other information processing device 90 may be substituted with an information processing device which is equivalent to the information processing device 20. In that case, drawing information inputted in a manner to extend continuously across a plurality of display devices at each information processing device 20 is sent to and received from the other information processing device 20 after it is corrected as necessary. As a result, even when there are differences between the two information processing devices in arrangement configuration of display devices and in positions and magnification for displaying contents, the information processing system 2 as an exemplary embodiment of the present invention can prevent discontinuous display of such drawing information at each of the information processing devices.

Although the above description has been given on the assumption that the information processing device 90 described in the present exemplary embodiment includes the contents acquisition unit 901, the contents output unit 903, the drawing information acquisition unit 904 and the display control unit 907, the information processing device referred to as “another information processing device” in the information processing system of the present invention only needs to include at least the contents output unit and the display control unit. That is, the information processing system of the present invention only needs to include at least the information processing device of the present invention which displays contents on a plurality of display devices and a terminal having at least functions to display contents received from the information processing device of the present invention and to redisplay the contents in a display mode where they are superposed with received drawing information. For example, the information processing system may be such that a presenter uses the information processing device of the present invention which displays contents on a plurality of display devices and the audience uses a browsing terminal including the contents output unit and the display control unit. Also in that case, the information processing system of the present invention can prevent that drawing information inputted by the presenter in a manner to extend across a plurality of display devices is discontinuously displayed on the browsing terminal held by the audience.

Further, the information processing system 2 as the present exemplary embodiment may include, in addition to the information processing device of the present invention, another information processing device which displays contents by treating a plurality of display devices as a single display area and still another information processing device which displays contents by treating a single display device as a single display area. It is obvious that, also in that case, the information processing system 2 as the present exemplary embodiment exhibits the same effect as that described above.

### Third Exemplary Embodiment

Next, a third exemplary embodiment of the present invention will be described in detail, with reference to drawings. In each of the drawings referred to in this description of the present exemplary embodiment, to configurations identical with and steps of operation similar to that in the first or second exemplary embodiments of the present invention, the respective same signs as that in the first or second exemplary embodiments are given, and their detailed descriptions will be omitted in the present exemplary embodiment.

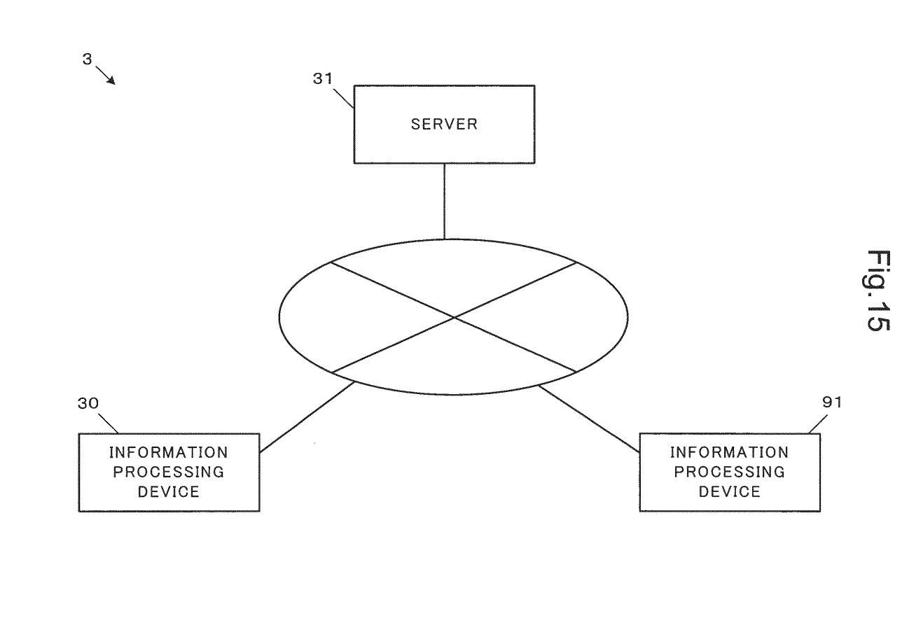

First, a configuration of an information processing system 3 as the third exemplary embodiment of the present invention is shown in FIG. 15. In FIG. 15, the information processing system 3 includes an information processing device 30, a server 31 and an information processing device 91. Here, the information processing device 30, the server 31 and the information processing device 91 are connected with each other via a network to enable mutual communication.

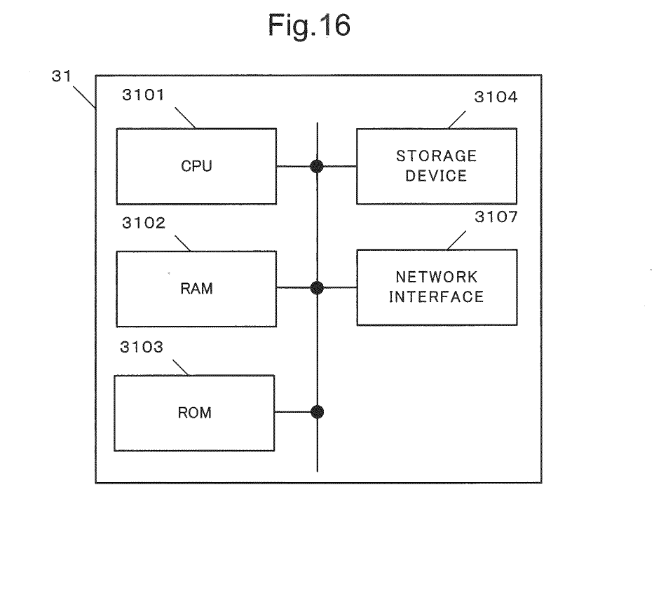

Next, hardware configuration of each of the devices constituting the information processing system 3 will be described. The information processing device 30 consists of a computer system which is similar to that constituting the information processing device 20 as the second exemplary embodiment of the present invention shown in FIG. 11. The information processing device 91 consists of a computer system which is similar to that constituting the information processing device 90 as the second exemplary embodiment of the present invention shown in FIG. 11. As shown in FIG. 16, the server 31 consists of a computer system including a CPU 3101, a RAM 3102, a ROM 3103, a storage device 3104 such as a hard disk and a network interface 3107.

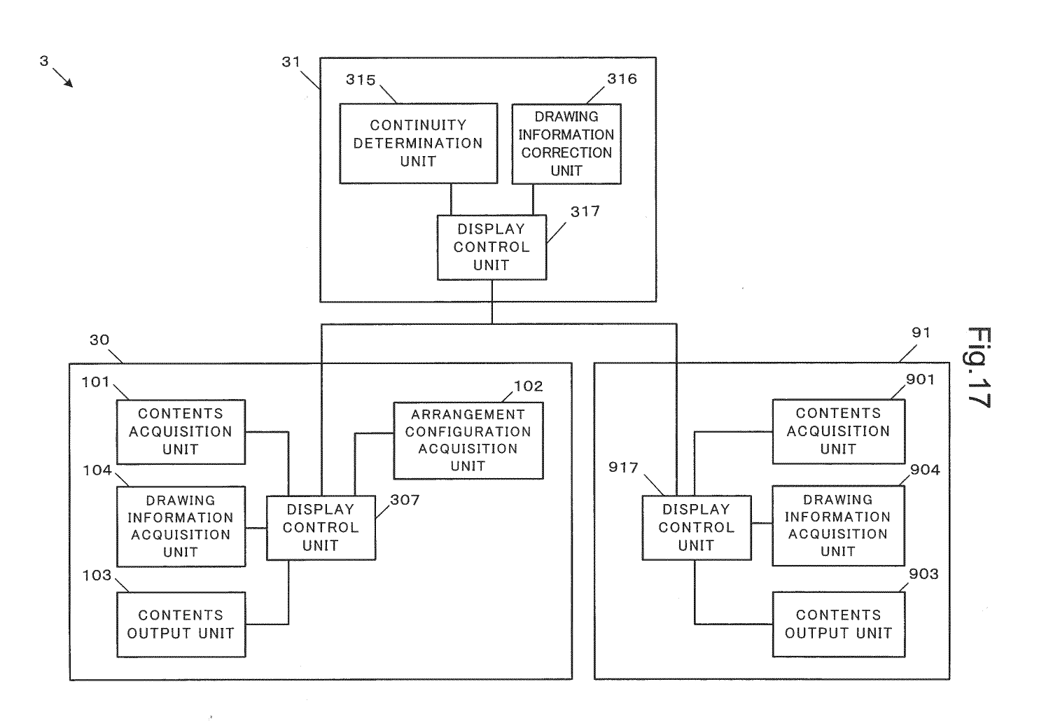

Next, functional block configurations of the respective devices constituting the information processing system 3 are shown in FIG. 17.

In FIG. 17, the information processing device 30 includes the contents acquisition unit 101, the arrangement configuration acquisition unit 102, the contents output unit 103, the drawing information acquisition unit 104 and a display control unit 307. The information processing device 91 includes the contents acquisition unit 901, the contents output unit 903, the drawing information acquisition unit 904 and the display control unit 917. The server 31 includes a continuity determination unit 315, a drawing information correction unit 316 and a display control unit 317. Here, the continuity determination unit 315 and the drawing information correction unit 316 are composed of the CPU 3101 which reads computer program modules and data stored in the storage device 3104 or the ROM 3103 into the RAM 3102 and then executes them. The display control unit 317 is composed of the CPU 3101 which reads computer program modules and data stored in the storage device 3104 or the ROM 3103 into the RAM 3102 and then executes them, and of the network interface 3107.

Of the information processing device 30, the contents acquisition unit 101, the arrangement configuration acquisition unit 102, the contents output unit 103 and the drawing information acquisition unit 104 are configured similarly to those in the first and second exemplary embodiments of the present invention.

The display control unit 307 is configured similarly to the display control unit 207 of the information processing device 20 in the second exemplary embodiment of the present invention, and thereby controls the contents output unit 103. However, the display control unit 307 differs from the display control unit 207 in that it sends and receives contents and drawing information to and from the server 31, instead of to and from the information processing device 90. That is, the display control unit 307 sends contents acquired by the contents acquisition unit 101 to the server 31. The display control unit 307 also notifies the contents output unit 103 to display contents received from the server 31. To the server 31, the display control unit 307 sends drawing information acquired by the drawing information acquisition unit 104 or that further corrected by the drawing information correction unit 106. The display control unit 307 also notifies the contents output unit 103 to redisplay contents in a display mode where drawing information received from the server 31 is superposed on the contents.

Of the information processing device 91, the contents acquisition unit 901, the contents output unit 903 and the drawing information acquisition unit 904 are configured similarly to those in the second exemplary embodiment of the present invention.

The display control unit 917 is configured similarly to the display control unit 907 of the information processing device 90 in the second exemplary embodiment of the present invention, and thereby controls the contents output unit 903. However, the display control unit 917 is different from the display control unit 907 in that it sends and receives contents and drawing information to and from the server 31, instead of to and from the information processing device 20. That is, the display control unit 917 sends contents acquired by the contents acquisition unit 901 to the server 31. The display control unit 917 also notifies the contents output unit 903 to display contents received from the server 31. To the server 31, the display control unit 917 sends drawing information acquired by the drawing information acquisition unit 904. The display control unit 917 also notifies the contents output unit 903 to redisplay contents in a display mode where drawing information received from the server 31 is superposed on the contents.

The display control unit 317 of the server 31 sends and receives contents and drawing information to and from both the information processing device 30 and the information processing device 91. Specifically, the display control unit 317 sends contents received from the information processing device 30 to the information processing device 91. The display control unit 317 also sends contents received from the information processing device 91 to the information processing device 30. The display control unit 317 sends also drawing information received from the information processing device 30 and then corrected by the drawing information correction unit 316, which will be described later, to both the information processing device 30 and the information processing device 91. The display control unit 317 also sends drawing information received from the information processing device 91 to both the information processing device 30 and the information processing device 91.

Further, the display control unit 317 receives information representing an arrangement configuration of the display devices 1005 from the information processing device 30, and stores the information.

The continuity determination unit 315 determines the presence or absence of an operator's intention of continuity between a plurality of pieces of drawing information received adjacently to each other in time from the same information processing device 30, similarly to the continuity determination unit 105 in the first and second exemplary embodiment of the present invention.

If the intention of continuity is determined to exist between the plurality of pieces of drawing information, the drawing information correction unit 316 corrects these pieces of drawing information to become continuous with each other. Thus corrected plurality of pieces of drawing information are sent by the display control unit 317 to both the information processing device 30 and the information processing device 91, as already described above.

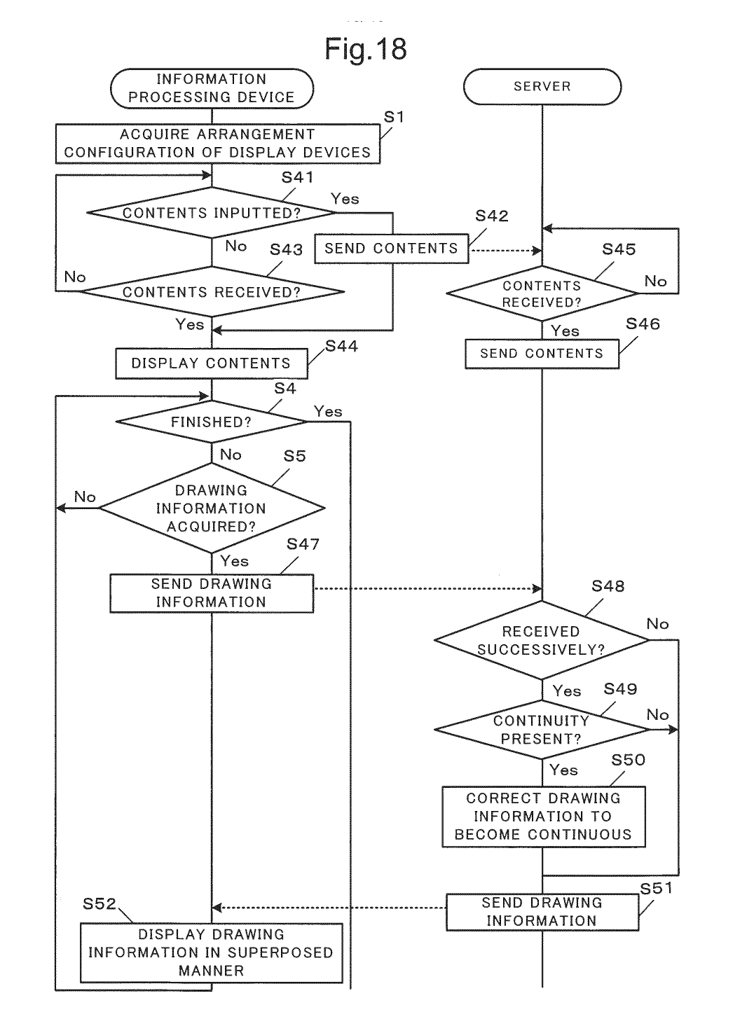

A description will be given below of operation of the information processing system 3 configured as described above, with reference to FIG. 18. In FIG. 18, the left part of the drawing shows operation of the information processing device 30, the right part does operation of the server 31, and dashed directional lines each represent a data flow. In FIG. 18, operation of the information processing device 91 is omitted from the drawing.

First, the arrangement configuration acquisition unit 102 of the information processing device 30 acquires information representing an arrangement configuration of the plurality of display devices 1005, similarly to in the first exemplary embodiment of the present invention (step S1).

Next, the contents acquisition unit 101 determines whether or not any input operation to designate contents has been performed, similarly to in the second exemplary embodiment of the present invention (step S41).

If, in the step S41, it is determined that an input operation to designate contents is performed, the display control unit 307 sends information representing the contents to the server 31 (Step S42). Then, the operation of the information processing system 3 proceeds to a step S44.

On the other hand, if it is determined in the step S41 that no input operation to designate contents has been performed, the display control unit 307 further determines whether or not any information representing contents has been received from the server 31 (step S43).

At this stage, if no information representing contents has been received, the operation of the information processing system 3 returns to the step S41.

On the other hand, if it is determined in the step S43 that information representing contents has been received, or if it has been already determined in the step S41 that an input operation to designate contents had been performed, the display control unit 307 notifies the contents output unit 103 to display the acquired contents on the display devices 1005 (step S44).

If the server receives contents from the information processing device 30 or the information processing device 91 (Yes at a Step S45), it sends the contents to the information processing device 91 or to the information processing device 30, respectively (step S46).

Also the information processing device 91, by operating similarly to the operations in the steps S41 to S44, displays contents which was acquired at itself or received from the server 31 on the display device 9005.

Next, the information processing device 30 acquires drawing information by operating in the steps S4 to S5 similarly to the information processing device 1 as the first exemplary embodiment of the present invention.

Then, the information processing device 30 sends the acquired drawing information to the server 31 (step S47).

Next, the server 31 having received the drawing information further determines whether a plurality of pieces of drawing information have been received in succession or not (step S48).

For example, if any further drawing information is received before the elapse of a predetermined time after receiving drawing information in the step 47, the continuity determination unit 105 may determine that these pieces of drawing information have been received in succession.

If determining, at this stage, that the two pieces of drawing information have been received in succession, the continuity determination unit 315 of the server 31 then determines whether or not there exists the operator's intention of continuity between the plurality of drawing information which have been received successively in the steps S47 and S48 (step S49). Details of the operation in the step S49 will be described later.

If, at this stage, the intention of continuity is determined to exist, the drawing information correction unit 316 corrects the plurality of drawing information to become continuous with each other (step S50).

Next, the display control unit 317 sends the drawing information corrected in the step S50 to both the information processing device 30 and the information processing device 91. On the other hand, if, in the step S49, the intention of continuity is determined not to exist, the display control unit 317 sends the drawing information having received no correction to both the information processing device 30 and the information processing device 91 (step S51). Receiving the drawing information sent in the step S51, the display control unit 307 of the information processing device 30 notifies the contents output unit 103 to redisplay the currently displayed contents in a display mode where the received drawing information is superposed on the contents (step S52).

Also the display control unit 917 of the information processing device 91 having received the drawing information sent in the step S51 notifies the contents output unit 903 to redisplay the currently displayed contents in a display mode where the received drawing information is superposed on the contents.

As a result, in the case the intention of continuity is determined to exist between the pieces of drawing information inputted successively at the information processing device 30, the information processing device 30 and the information processing device 91 display these pieces of drawing information corrected by the server 31, in a manner to superpose them on the contents. In the other case where the intention of continuity is determined not to exist between the pieces of drawing information inputted successively at the information processing device 30, the information processing device 30 and the information processing device 91 display these pieces of drawing information as they are, in a manner to superpose them on the contents.

With that, the description of an outline of the operation of the information processing system 3 is finished.

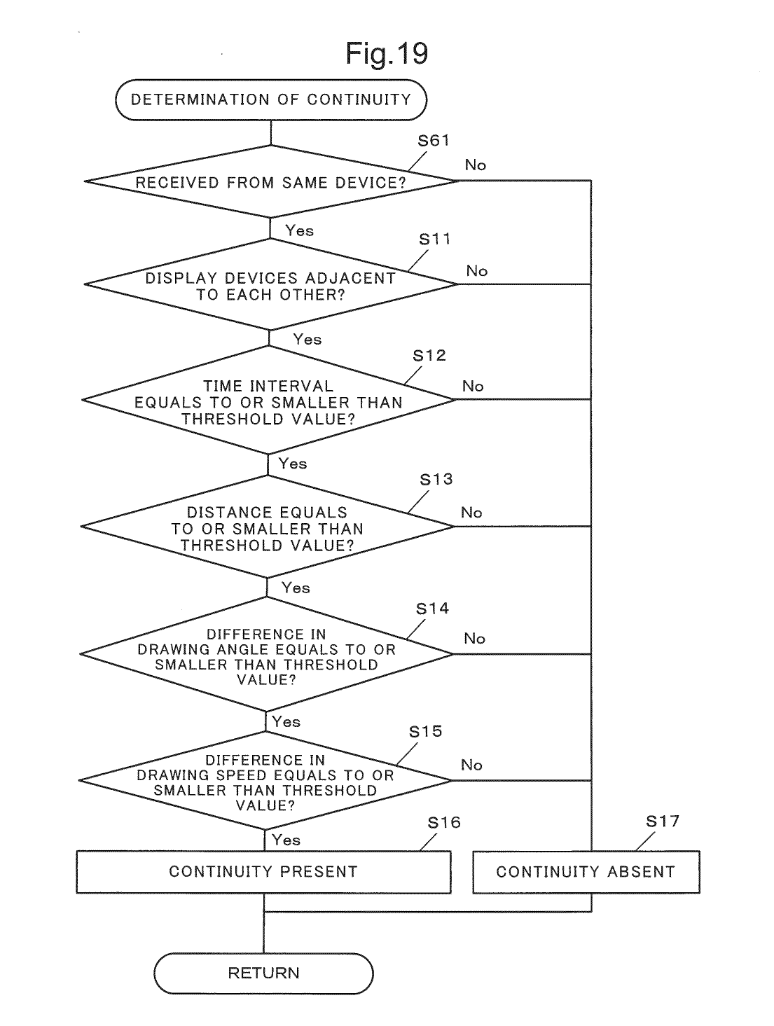

Next, the continuity determination operation of the server 31 in the step S49 will be described, with reference to FIG. 19.

In this operation, the continuity determination unit 315 of the server 31 firstly determines whether or not the pieces drawing information received successively are the ones received from the same information processing device 30 (step S61).

If determining, at this stage, that the pieces of drawing information were not received from the same information processing device 30, the continuity determination unit 315 determines that there exists none of the operator's intention of continuity between these pieces of drawing information (step S17).

On the other hand, if determining that the pieces of drawing information were received from the same information processing device 30, the continuity determination unit 315 determines the presence or absence of the intention of continuity on the basis of information obtained from each of the pieces of drawing information, by operating similarly to the operations in the steps S11 to S17 in the first exemplary embodiment of the present invention.

With that, the description of the continuity determination operation of the server 31 is finished.

In the step S48 in FIG. 18, the continuity determination unit 315 may acquire three or more pieces of drawing information as successive pieces of drawing information, by sequentially acquiring pieces of drawing information until it occurs that no subsequent drawing information is received before the elapse of a predetermined time since the last reception of drawing information.

In that case, the continuity determination unit 315 may determine whether or not there exists the intention of continuity between the three or more pieces of drawing information by executing the steps S11 to S17 on each pair of pieces of drawing information adjacent to each other in time.

Also in that case, the drawing information correction unit 316 may correct, to make them continuous with each other, some pieces of drawing information determined to be given the intention of continuity and thus extracted from among the plurality of drawing information received successively. Then, the display control unit 317 sends the corrected drawing information to both the information processing device 30 and the information processing device 91. The display control unit 317 may also send to both the information processing device 30 and the information processing device 91 the rest pieces of information, among the plurality of drawing information received successively, which are determined not to be given the intention of continuity, as they are.

Next, the effect of the third exemplary embodiment of the present invention will be described.

The information processing system 3 as the third exemplary embodiment of the present invention can reduce the processing load on the information processing device which is capable of preventing drawing information from being discontinuously displayed at another information processing device. This drawing information is drawing information inputted in a manner to extend continuously across a plurality of display devices. The reduction of the processing load is because of that the presence or absence of an operator's intention of continuity between pieces of drawing information extending across the plurality of display devices is determined at the server side and, if the intention of continuity is determined to exist, the pieces of drawing information are corrected to become continuous with each other at the server side, and then the server sends the corrected drawing information to each of the information processing devices at once.

In the third exemplary embodiment of the present invention, the information processing device 91 referred to as “another information processing device” in the present invention may include a plurality of display devices 9005.

Further, in the third exemplary embodiment of the present invention, the information processing device 30 may be adopted also as the other information processing device 91. In that case, because, even when drawing information extending across a plurality of display devices is inputted, each of the information processing devices 30 sends the drawing information to the server 31, thereby receives back the drawing information having received a correction to improve its continuity from the server 31, and then displays the corrected drawing information in a superposed manner, it can be prevented that drawing information inputted to any one of the information processing devices 30 is displayed discontinuously at the other one of the information processing devices 30.

Although the above description has been given on the assumption that the information processing device 91 in the third exemplary embodiment of the present invention includes the contents acquisition unit 901, the contents output unit 903, the drawing information acquisition unit 904 and the display control unit 917, the other information processing device in the information processing system of the present invention only needs to include at least the contents output unit and the display control unit. That is, the information processing system of the present invention only needs to include the information processing device of the present invention which displays contents on a plurality of display devices, the server and a terminal having at least functions to display contents received from the server and to redisplay them in a display mode where received drawing information is superposed on them.

Further, the information processing system 3 as the third exemplary embodiment of the present invention may include, in addition to the server and the information processing device of the present invention, another information processing device which displays contents by treating a plurality of display devices as a single display area and still another information processing device which displays contents by treating one display device as a single display area. It is obvious that, also in that case, the information processing system as the present exemplary embodiment exhibits the same effect as that already described above.

In each of the above-described exemplary embodiments of the present invention, the display control unit included in the information processing device which displays contents by treating a plurality of display devices as a single display area may control the contents output unit, even in the case of a plurality of pieces of drawing information having been determined to be given the intention of continuity, firstly to display the drawing information before the correction in a superposed manner and, as necessary, to display the drawing information after the correction also in a superposed manner. For example, when, after controlling the contents output unit to display the drawing information before the correction in a superposed manner, a discontinuous part of the drawing information comes to be displayed on a single display device due to scrolling, change in display magnification or the like, the display control unit may control the contents output unit to display the drawing information after the correction in a superposed manner. In the second and third exemplary embodiments of the present invention, with respect to a plurality of pieces of drawing information having been determined to be given the intention of continuity, the display control unit included in the information processing device which displays contents by treating a plurality of display devices as a single display area may control the contents output unit of the own information processing device to display the drawing information before the correction, while sending the drawing information after the correction to the other information processing device or the server. Also in that case, when, after performing such control, there occurs necessity such as described above, the display control unit included in the information processing device which displays contents by treating a plurality of display devices as a single display area may notify the display control unit of the own information processing device to display the drawing information after the correction in a superposed manner. As a result, the information processing devices as the respective exemplary embodiments of the present invention can prevent drawing information inputted in a manner to extend continuously across a plurality of display devices from being displayed discontinuously. Further, the information processing device as the respective exemplary embodiments of the present invention can reduce an operator's uneasiness at the time of input operation about that such drawing information is not displayed to be the same locus as the inputted one.

In each of the above-described exemplary embodiments of the present invention, the description has been given mainly of the sample in which the information processing device of the present invention has, as the input devices, a plurality of touch panels integrated with respective ones of a plurality of display devices, but an input device intended to be used in the information processing devices of the present invention is not limited to a touch panel. For example, an input device intended to be used in the information processing devices of the present invention may be a mouse which is capable of designating information on coordinates in every display area of a plurality of display devices. Also in that case, when display devices currently displaying areas in which two pieces of drawing information acquired adjacently to each other in time are respectively superposed are arranged adjacently to each other, the continuity determination unit in the present invention may determine the presence or absence of intention of continuity between the two pieces of drawing information.

The above descriptions of the respective exemplary embodiments of the present invention have also been focused mainly on the samples in each of which the information processing device includes, in an integrated manner, a plurality of display devices and input devices for acquiring information on coordinates in the display areas of the plurality of display devices, but the information processing devices of the present invention do not necessarily need to be integrated with the display devices and the input devices. For example, the information processing devices of the present invention may be connected with a plurality of external display devices and external input devices.

In each of the exemplary embodiments of the present invention, the description has been given of the sample in which contents are displayed by treating all of a plurality of display devices included in the information processing device of the present invention as a single display area, but the information processing devices of the present invention do not necessarily need to be configured to regard all of a plurality of controllably connected display devices as a single display area. For example, the information processing devices of the present invention may be the ones which display contents by treating only some of a plurality of controllably connected display devices. In such a case, the information processing devices of the present invention may be configured to be able to change the combination of display devices which can collectively display contents as a single display area.

Further, in each of the above-described exemplary embodiments of the present invention, the configuration may be such that the operation (processing, functions) by the information processing device described with reference to the corresponding flow chart is stored as a computer program of the present invention into a storage device (recording medium) of a computer system, and the CPU of the computer system reads out and executes the computer program. In that case, the present invention consists of source code constituting the computer program or of a computer-readable recording medium storing the computer program.

The above-described exemplary embodiments may be implemented in combination with each other appropriately.

Further, the present invention is not limited to the above-described exemplary embodiments, but may be implemented in a variety of forms.

Part or the whole of the above-mentioned exemplary embodiments may also be described as the following supplementary notes, but are not limited to them.

(supplementary note 1)

An information processing device comprising: a contents acquisition unit which acquires contents;

an arrangement configuration acquisition unit which acquires an arrangement configuration of a plurality of display devices;

a contents output unit which displays the contents by regarding the plurality of display devices as a single display area on the basis of the arrangement configuration;

a drawing information acquisition unit which, with respect to each of the display devices, acquires drawing information to be displayed along with currently displayed the contents in a display mode where the drawing information is superposed on the contents, via an input device which acquires information on coordinates within each display area of the plurality of display devices;

a continuity determination unit which, if display devices displaying areas in which a plurality of pieces of the drawing information acquired adjacently to each other in time are respectively superposed are arranged adjacently to each other, determines whether or not there exists an operator's intention of continuity between the plurality of pieces of drawing information;

a drawing information correction unit which, if the intention of continuity is determined to exist between the plurality of pieces of drawing information, corrects the plurality of pieces of drawing information to become continuous with each other; and

a display control unit which controls the contents output unit to redisplay the drawing information corrected by the drawing information correction unit along with the contents in a display mode where the drawing information is superposed on the contents.

(supplementary note 2)

The information processing device according to supplementary note 1, which is characterized by that

the display control unit sends the plurality of pieces of drawing information after correction to another information processing device which displays the contents by regarding one or more display device as a single display area and redisplays currently displayed the contents in a display mode where the drawing information is superposed on the contents, and thereby controls the another information processing device to redisplay the plurality of pieces of drawing information after correction in a display mode where they are superposed on the contents.

(supplementary note 3)

The information processing device according to supplementary notes 1 or 2, which is characterized by that

the continuity determination unit determines the presence or absence of the intention of continuity between the plurality of pieces of drawing information, on the basis of the time interval from the input end time of one of the plurality of pieces of drawing information to the input start time of another one of the plurality of pieces of drawing information acquired next to the former one.

(supplementary note 4)

The information processing device according to any one of supplementary notes 1 to 3, which is characterized by that the continuity determination unit determines the presence or absence of the intention of continuity between the plurality of pieces of drawing information, on the basis of the distance from the end-point coordinate of one of the plurality of pieces of drawing information to the start-point coordinate of another one of the plurality of pieces of drawing information acquired next to the former one.

(supplementary note 5)

The information processing device according to any one of supplementary notes 1 to 4, which is characterized by that the continuity determination unit determines the presence or absence of the intention of continuity between the plurality of pieces of drawing information, on the basis of the drawing angle of one of the plurality of pieces of drawing information and that of another one of the plurality of pieces of drawing information acquired next to the former one.

(supplementary note 6)

The information processing device according to any one of supplementary notes 1 to 5, which is characterized by that the continuity determination unit determines the presence or absence of the intention of continuity between the plurality of pieces of drawing information, on the basis of the drawing speed of one of the plurality of pieces of drawing information and that of another one of the plurality of pieces of drawing information acquired next to the former.

(supplementary note 7)

An information processing system comprising: an information processing device according to any one of supplementary notes 2 to 6; and

the another information processing device.

(supplementary note 8)

An information processing system comprising: an information processing device capable of displaying contents on a plurality of display devices;

another information processing device capable of displaying contents on one or more display devices; and

a server,

wherein

the information processing device comprises:

a contents acquisition unit which acquires contents;

an arrangement configuration acquisition unit which acquires an arrangement configuration of a plurality of display devices;

a contents output unit which displays the contents by regarding the plurality of display devices as a single display area on the basis of the arrangement configuration;

a drawing information acquisition unit which, with respect to each of the display devices, acquires drawing information to be displayed along with currently displayed the contents in a display mode where the drawing information is superposed on the contents, via an input device which acquires information on coordinates within each display area of the plurality of display devices; and

a display control unit which sends and receives the contents and the drawing information to and from the server, and controls the contents output unit to redisplay the contents and the drawing information,

and

the server comprises:

a display control unit which performs control to make display contents shared between the information processing device and the another information processing device, by sending and receiving the contents and the drawing information to and from the information processing device and the another information processing device;

a continuity determination unit which determines whether or not there exists an operator's intention of continuity between a plurality of pieces of the drawing information acquired adjacently to each other in time, among pieces of drawing information received from the information processing device, if display devices displaying areas in which the plurality of pieces of drawing information acquired adjacently to each other in time are respectively superposed are arranged adjacently to each other; and

a drawing information correction unit which, if the intention of continuity is determined to exist between the plurality of pieces of drawing information, corrects the plurality of pieces of drawing information to become continuous with each other, and subsequently causes the display control unit to send the corrected drawing information,

and

the another information processing device comprises at least:

a contents output unit which outputs the contents to the one or more display devices; and

a display control unit which controls the contents output unit to redisplay drawing information received from the server along with the contents in a display mode where the drawing information is superposed on the contents.

(supplementary note 9)

An information processing device comprising:

a contents acquisition unit which acquires contents;

an arrangement configuration acquisition unit which acquires an arrangement configuration of a plurality of display devices;

a contents output unit which displays the contents by regarding the plurality of display devices as a single display area on the basis of the arrangement configuration;

a drawing information acquisition unit which, with respect to each of the display devices, acquires drawing information to be displayed in a manner to be superposed on currently displayed the contents, via an input device which acquires information on coordinates within each display area of the plurality of display devices; and

a display control unit which: sends and receives the contents and the drawing information to and from a sever which determines the presence or absence of an operator's intention of continuity between a plurality of pieces of drawing information acquired adjacently to each other in time, among pieces of the drawing information, and, if the intention of continuity exists, corrects the plurality of pieces of drawing information to become continuous with each other; and causes the contents output unit to display thus received the contents and the drawing information.

(supplementary note 10)

A server connected, in a manner to enable mutual communication, with an information processing device which displays contents by regarding a plurality of display devices as a single display area and acquires drawing information to be displayed along with the contents in a display mode where the drawing information is superposed on the contents, and with another information processing device which displays the contents by regarding one or more display devices as a single display area and redisplays the drawing information along with the contents in a display mode where the drawing information is superposed on the contents, the server comprising:

a display control unit which performs control to make display contents shared between the information processing device and the another information processing device, by sending and receiving the contents and the drawing information to and from the information processing device and the another information processing device;

a continuity determination unit which determines whether or not there exists an operator's intention of continuity between a plurality of pieces of the drawing information acquired adjacently to each other in time, among pieces of drawing information received from the information processing device, if display devices displaying areas in which the plurality of pieces of drawing information acquired adjacently to each other in time are respectively superposed are arranged adjacently to each other; and

a drawing information correction unit which, if the intention of continuity is determined to exist between the plurality of pieces of drawing information, corrects the plurality of pieces of drawing information to become continuous with each other, and subsequently causes the display control unit to send the corrected drawing information,

(supplementary note 11)

An information processing method comprising: acquiring contents;

acquiring an arrangement configuration of a plurality of display devices;

displaying the contents by regarding the plurality of display devices as a single display area on the basis of the arrangement configuration;

acquiring, with respect to each of the display devices, drawing information to be displayed along with currently displayed the contents in a display mode where the drawing information is superposed on the contents, via an input device which acquires information on coordinates within each display area of the plurality of display devices;

determining whether or not there exists an operator's intention of continuity between a plurality of pieces of the drawing information acquired adjacently to each other in time, if display devices displaying areas in which the plurality of pieces of drawing information acquired adjacently to each other in time are respectively superposed are arranged adjacently to each other;

correcting the plurality of pieces of drawing information to become continuous with each other, if the intention of continuity is determined to exist between the plurality of pieces of drawing information; and

redisplaying the plurality of pieces of drawing information after correction along with the contents in a display mode where the plurality of pieces of drawing information are superposed on the contents, on the plurality of display devices regarded as a single display area.

(supplementary note 12)

The information processing method according to supplementary note 11, further comprising

sending the contents and the plurality of pieces drawing information after correction to another information processing device which displays the contents on one or more display devices and redisplays the contents in a display mode where the drawing information is superposed on currently displayed contents, and thereby sharing display contents with the another information processing device.

(supplementary note 13)

A computer program for causing a computer system to execute:

a content acquisition process of acquiring contents;

an arrangement configuration acquisition process of acquiring an arrangement configuration of a plurality of display devices;

a content output process of displaying the contents by regarding the plurality of display devices as a single display area on the basis of the arrangement configuration;

a drawing information acquisition process of acquiring, with respect to each of the display devices, drawing information to be displayed along with currently displayed the contents in a display mode where the drawing information is superposed on the contents, via an input device which acquires information on coordinates within each display area of the plurality of display devices;

a continuity determination process of determining whether or not there exists an operator's intention of continuity between a plurality of pieces of the drawing information acquired adjacently to each other in time, if display devices displaying areas in which the plurality of pieces of drawing information acquired adjacently to each other in time are respectively superposed are arranged adjacently to each other;

a drawing information correction process of correcting the plurality of pieces of drawing information to become continuous with each other, if the intention of continuity is determined to exist between the plurality of pieces of drawing information; and

a redisplay process of redisplaying the plurality of pieces of drawing information after correction along with the contents in a display mode where the plurality of pieces of drawing information are superposed on the contents, on the plurality of display devices regarded as a single display area.

(supplementary note 14)

The computer program according to supplementary note 13, which is characterized by that it causes the computer system to further execute a drawing information sending process of sending the contents and the plurality of pieces drawing information after correction to another information processing device which displays the contents on one or more display devices and redisplays the contents in a display mode where the drawing information is superposed on currently displayed contents.

(supplementary note 15)

A computer program for causing a computer system to execute: a drawing information reception process of receiving the drawing information from an information processing device which displays contents by regarding a plurality of display devices as a single display area and acquires drawing information to be displayed along with the contents in a display mode where the drawing information is superposed on the contents, and from another information processing device which displays the contents by regarding one or more display devices as a single display area and redisplays the drawing information along with the contents in a display mode where the drawing information is superposed on the contents;

a continuity determination process of determining whether or not there exists an operator's intention of continuity between a plurality of pieces of the drawing information acquired adjacently to each other in time, among pieces of drawing information received from the information processing device, if display devices displaying areas in which the plurality of pieces of drawing information acquired adjacently to each other in time are respectively superposed are arranged adjacently to each other;

a drawing information correction process of correcting the plurality of pieces of drawing information to become continuous with each other, if the intention of continuity is determined to exist between the plurality of pieces of drawing information; and

a corrected drawing information sending process of sending corrected drawing information to the information processing device and the another information processing device.

This application is based upon and claims the benefit of priority from Japanese application Japanese Patent Application No. 2011-137647, filed on Jun. 21, 2011, the disclosure of which is incorporated herein in its entirety by reference.

### REFERENCE SIGNS LIST

1, 20, 30, 90, 91 information processing device
2, 3 information processing system
31 server
101, 901 contents acquisition unit
102 arrangement configuration acquisition unit
103, 903 contents output unit
104, 904 drawing information acquisition unit
105, 315 continuity determination unit
106, 316 drawing information correction unit
107, 207, 307, 317, 907, 917 display control unit
1001, 3101, 9001 CPU
1002, 3102, 9002 RAM
1003, 3103, 9003 ROM
1004, 3104, 9004 storage device
1005, 9005 display device
1006, 9006 input device
2007, 9007, 3107 network interface

What is claimed is:

1.-10. (canceled)

11. An information processing device comprising:
a contents acquisition unit which acquires contents;
an arrangement configuration acquisition unit which acquires an arrangement configuration of a plurality of display devices;
a contents output unit which displays the contents by regarding the plurality of display devices as a single display area on the basis of the arrangement configuration;
a drawing information acquisition unit which, with respect to each of the display devices, acquires drawing information to be displayed along with currently displayed the contents in a display mode where the drawing information is superposed on the contents, via an input device which acquires information on coordinates within each display area of the plurality of display devices;
a continuity determination unit which, if display devices displaying areas in which a plurality of pieces of the drawing information acquired adjacently to each other in time are respectively superposed are arranged adjacently to each other, determines whether or not there exists an operator's intention of continuity between the plurality of pieces of drawing information;
a drawing information correction unit which, if the intention of continuity is determined to exist between the plurality of pieces of drawing information, corrects the plurality of pieces of drawing information to become continuous with each other; and
a display control unit which controls the contents output unit to redisplay the drawing information corrected by the drawing information correction unit along with the contents in a display mode where the drawing information is superposed on the contents.

12. The information processing device according to claim 11, wherein the display control unit sends the plurality of pieces of drawing information after correction to another information processing device which displays the contents by regarding one or more display device as a single display area and redisplays currently displayed the contents in a display mode where the drawing information is superposed on the contents, and thereby controls the another information processing device to redisplay the plurality of pieces of drawing information after correction in a display mode where they are superposed on the contents.

13. The information processing device according to claim 11, wherein the continuity determination unit determines the presence or absence of the intention of continuity between the plurality of pieces of drawing information, on the basis of the time interval from the input end time of one of the plurality of pieces of drawing information to the input start time of another one of the plurality of pieces of drawing information acquired next to the former one.

14. The information processing device according to claim 12, wherein the continuity determination unit determines the presence or absence of the intention of continuity between the plurality of pieces of drawing information, on the basis of the time interval from the input end time of one of the plurality of pieces of drawing information to the input start time of another one of the plurality of pieces of drawing information acquired next to the former one.

15. The information processing device according to any one of claim 11, wherein the continuity determination unit determines the presence or absence of the intention of continuity between the plurality of pieces of drawing information, on the basis of the drawing angle of one of the plurality of pieces of drawing information and that of another one of the plurality of pieces of drawing information acquired next to the former one.

16. The information processing device according to claim 12, wherein the continuity determination unit determines the presence or absence of the intention of continuity between the plurality of pieces of drawing information, on the basis of the drawing angle of one of the plurality of pieces of drawing information and that of another one of the plurality of pieces of drawing information acquired next to the former one.

17. The information processing device according to claim 13, wherein the continuity determination unit determines the presence or absence of the intention of continuity between the plurality of pieces of drawing information, on the basis of the drawing angle of one of the plurality of pieces of drawing information and that of another one of the plurality of pieces of drawing information acquired next to the former one.

18. The information processing device according to claim 11, wherein the continuity determination unit determines the presence or absence of the intention of continuity between the plurality of pieces of drawing information, on the basis of the drawing speed of one of the plurality of pieces of drawing information and that of another one of the plurality of pieces of drawing information acquired next to the former.

19. The information processing device according to claim 12, wherein the continuity determination unit determines the presence or absence of the intention of continuity between the plurality of pieces of drawing information, on the basis of the drawing speed of one of the plurality of pieces of drawing information and that of another one of the plurality of pieces of drawing information acquired next to the former.

20. The information processing device according to claim 13, wherein the continuity determination unit determines the presence or absence of the intention of continuity between the plurality of pieces of drawing information, on the basis of the drawing speed of one of the plurality of pieces of drawing information and that of another one of the plurality of pieces of drawing information acquired next to the former.

21. The information processing device according to claim 15, wherein the continuity determination unit determines the presence or absence of the intention of continuity between the plurality of pieces of drawing information, on the basis of the drawing speed of one of the plurality of pieces of drawing information and that of another one of the plurality of pieces of drawing information acquired next to the former.

22. An information processing system comprising:
an information processing device according to claim 12; and
the another information processing device.

23. An information processing system comprising:
an information processing device according to claim 13; and
the another information processing device.

24. An information processing system comprising:
an information processing device according to claim 15; and
the another information processing device.

25. An information processing system comprising:
an information processing device according to claim 18; and
the another information processing device.

26. An information processing system comprising:
an information processing device capable of displaying contents on a plurality of display devices;
another information processing device capable of displaying contents on one or more display devices; and
a server,
wherein
the information processing device comprises:
a contents acquisition unit which acquires contents;
an arrangement configuration acquisition unit which acquires an arrangement configuration of a plurality of display devices;
a contents output unit which displays the contents by regarding the plurality of display devices as a single display area on the basis of the arrangement configuration;
a drawing information acquisition unit which, with respect to each of the display devices, acquires drawing information to be displayed along with currently displayed the contents in a display mode where the drawing information is superposed on the contents, via an input device which acquires information on coordinates within each display area of the plurality of display devices; and
a display control unit which sends and receives the contents and the drawing information to and from the server, and controls the contents output unit to redisplay the contents and the drawing information,
and
the server comprises:
a display control unit which performs control to make display contents shared between the information processing device and the another information processing device, by sending and receiving the contents and the drawing information to and from the information processing device and the another information processing device;
a continuity determination unit which determines whether or not there exists an operator's intention of continuity between a plurality of pieces of the drawing information acquired adjacently to each other in time, among pieces of drawing information received from the information processing device, if display devices displaying areas in which the plurality of pieces of drawing information acquired adjacently to each other in time are respectively superposed are arranged adjacently to each other; and
a drawing information correction unit which, if the intention of continuity is determined to exist between the plurality of pieces of drawing information, corrects the plurality of pieces of drawing information to become continuous with each other, and subsequently causes the display control unit to send the corrected drawing information,
and
the another information processing device comprises at least:
a contents output unit which outputs the contents to the one or more display devices; and
a display control unit which controls the contents output unit to redisplay drawing information received from the server along with the contents in a display mode where the drawing information is superposed on the contents.

27. A server connected, in a manner to enable mutual communication, with an information processing device which displays contents by regarding a plurality of display devices as a single display area and acquires drawing information to be displayed along with the contents in a display mode where the drawing information is superposed on the contents, and with another information processing device which displays the contents by regarding one or more display devices as a single display area and redisplays the drawing information along with the contents in a display mode where the drawing information is superposed on the contents, the server comprising:
a display control unit which performs control to make display contents shared between the information processing device and the another information processing device, by sending and receiving the contents and the drawing information to and from the information processing device and the another information processing device;
a continuity determination unit which determines whether or not there exists an operator's intention of continuity between a plurality of pieces of the drawing information acquired adjacently to each other in time, among pieces of drawing information received from the information processing device, if display devices displaying areas in which the plurality of pieces of drawing information acquired adjacently to each other in time are respectively superposed are arranged adjacently to each other; and
a drawing information correction unit which, if the intention of continuity is determined to exist between the plurality of pieces of drawing information, corrects the plurality of pieces of drawing information to become continuous with each other, and subsequently causes the display control unit to send the corrected drawing information,

28. An information processing method comprising:
acquiring contents;
acquiring an arrangement configuration of a plurality of display devices;
displaying the contents by regarding the plurality of display devices as a single display area on the basis of the arrangement configuration;
acquiring, with respect to each of the display devices, drawing information to be displayed along with currently displayed the contents in a display mode where the drawing information is superposed on the contents, via an input device which acquires information on coordinates within each display area of the plurality of display devices;
determining whether or not there exists an operator's intention of continuity between a plurality of pieces of the drawing information acquired adjacently to each other in time, if display devices displaying areas in which the plurality of pieces of drawing information acquired adjacently to each other in time are respectively superposed are arranged adjacently to each other;
correcting the plurality of pieces of drawing information to become continuous with each other, if the intention of continuity is determined to exist between the plurality of pieces of drawing information; and
redisplaying the plurality of pieces of drawing information after correction along with the contents in a display mode where the plurality of pieces of drawing information are superposed on the contents, on the plurality of display devices regarded as a single display area.

29. A non-transitory computer-readable medium which stores an information processing program causing a computer to executes:
a content acquisition process of acquiring contents;
an arrangement configuration acquisition process of acquiring an arrangement configuration of a plurality of display devices;
a content output process of displaying the contents by regarding the plurality of display devices as a single display area on the basis of the arrangement configuration;
a drawing information acquisition process of acquiring, with respect to each of the display devices, drawing information to be displayed along with currently displayed the contents in a display mode where the drawing information is superposed on the contents, via an input device which acquires information on coordinates within each display area of the plurality of display devices;
a continuity determination process of determining whether or not there exists an operator's intention of continuity between a plurality of pieces of the drawing information acquired adjacently to each other in time, if display devices displaying areas in which the plurality of pieces of drawing information acquired adjacently to each other in time are respectively superposed are arranged adjacently to each other;
a drawing information correction process of correcting the plurality of pieces of drawing information to become continuous with each other, if the intention of continuity is determined to exist between the plurality of pieces of drawing information; and
a redisplay process of redisplaying the plurality of pieces of drawing information after correction along with the contents in a display mode where the plurality of pieces of drawing information are superposed on the contents, on the plurality of display devices regarded as a single display area.

30. An information processing device comprising:
a contents acquisition unit which acquires contents;
an arrangement configuration acquisition unit means which acquires an arrangement configuration of a plurality of display devices;
a contents output means which displays the contents by regarding the plurality of display devices as a single display area on the basis of the arrangement configuration;
a drawing information acquisition means which, with respect to each of the display devices, acquires drawing information to be displayed along with currently displayed the contents in a display mode where the drawing information is superposed on the contents, via an input device which acquires information on coordinates within each display area of the plurality of display devices;
a continuity determination means which, if display devices displaying areas in which a plurality of pieces of the drawing information acquired adjacently to each other in time are respectively superposed are arranged adjacently to each other, determines whether or not there exists an operator's intention of continuity between the plurality of pieces of drawing information;
a drawing information correction means which, if the intention of continuity is determined to exist between the plurality of pieces of drawing information, corrects the plurality of pieces of drawing information to become continuous with each other; and
a display control means which controls the contents output unit to redisplay the drawing information corrected by the drawing information correction unit along with the contents in a display mode where the drawing information is superposed on the contents.
